(19) United States
(12) Patent Application Publication
(10) Pub. No.: US 2014/0324591 A1
(43) Pub. Date: Oct. 30, 2014

(54) SELECTIVELY AUTHENTICATING A GROUP OF DEVICES AS BEING IN A SHARED ENVIRONMENT BASED ON LOCALLY CAPTURED AMBIENT SOUND

(71) Applicant: QUALCOMM Incorporated, San Diego, CA (US)

(72) Inventors: Taesu KIM, Seongnam (KR); Ravinder Paul CHANDHOK, Del Mar, CA (US); Te-Won LEE, San Diego, CA (US)

(73) Assignee: QUALCOMM Incorporated, San Diego, CA (US)

(21) Appl. No.: 14/263,784

(22) Filed: Apr. 28, 2014

Related U.S. Application Data
(60) Provisional application No. 61/817,153, filed on Apr. 29, 2013.
(60) Provisional application No. 61/817,164, filed on Apr. 29, 2013.

(51) Int. Cl. H04W 12/06; G06Q 30/02; H04W 12/04

(52) U.S. Cl. CPC H04W 12/06; H04W 12/04; G06Q 30/0261
USPC 705/14.58; 455/411; 455/552.1

(57) ABSTRACT

In an embodiment, two or more local wireless peer-to-peer connected user equipments (UEs) capture local ambient sound, and report information associated with the captured local ambient sound to an authentication device. The authentication device compares the reported information to determine a degree of environmental similarity for the UEs, and selectively authenticates the UEs as being in a shared environment based on the determined degree of environmental similarity. A given UE among the two or more UEs selects a target UE for performing a given action based on whether the authentication device authenticates the UEs as being in the shared environment.

### CLAIM OF PRIORITY UNDER 35 U.S.C. §119

The present application for patent claims priority to Provisional Application No. 61/817,153, entitled “SELECTIVELY AUTHENTICATING A GROUP OF DEVICES AS BEING IN A SHARED ENVIRONMENT BASED ON LOCALLY CAPTURED AMBIENT SOUND”, filed on Apr. 29, 2013, and also to U.S. Application No. 61/817,164, entitled “SELECTIVELY GENERATING A SHARED SECRET KEY FOR A GROUP OF DEVICES BASED ON WHETHER LOCALLY CAPTURED AMBIENT SOUND AUTHENTICATES THE GROUP OF DEVICES AS BEING IN A SHARED ENVIRONMENT”, filed on Apr. 29, 2013, each of which is by the same inventors as the subject application, and each of which is assigned to the assignee hereof and hereby expressly incorporated by reference herein in its entirety.

### BACKGROUND OF THE INVENTION

1. Field of the Invention

Embodiments of the invention relate to selectively authenticating a group of devices as being in a shared environment based on local ambient sound.

2. Description of the Related Art

User equipments (UEs) such as telephones, tablet computers, laptop and desktop computers, certain vehicles, etc., can be configured to connect with each other either locally (e.g., Bluetooth, local WiFi, etc.) or remotely (e.g., via cellular networks, through the Internet, etc.). Connection establishment between UEs can sometimes trigger actions by one or more of the connected UEs. For example, an operator may be engaged in a telephone call via a Bluetooth-equipped handset while approaching his/her vehicle when the operator decides to trigger a remote start of the vehicle. In this case, the operator is not yet actually inside of the vehicle, but certain actions such as transferring call functions from the handset to the vehicle may be triggered automatically, which can frustrate the operator and degrade user experience for the call (e.g., the handset stops capturing and/or playing call audio and the vehicle starts capturing and playing call audio when the operator is not even in the car yet). Thereby, merely identifying proximity or connection establishment is not necessarily sufficient to conclude that two UEs are operating in a shared environment.

Also, shared secret keys (SSKs) (e.g., passwords, passphrases, etc.) are commonly used for authenticating devices to each other. An SSK is any piece of data that is expected to be known only to a set of authorized parties, so that the SSK can be used for the purpose of authentication. SSKs can be created at the start of a communication session, whereby the SSKs are generated in accordance with a key-agreement protocol (e.g., a public-key cryptographic protocol such as Diffie-Hellman, or a symmetric-key cryptographic protocol such as Kerberos). Alternatively, a more secure type of SSK referred to a pre-shared key (PSK) can be used, whereby the PSK is exchanged over a secure channel before being used for authentication.

### SUMMARY

In an embodiment, two or more local wireless peer-to-peer connected user equipments (UEs) capture local ambient sound, and report information associated with the captured local ambient sound to an authentication device. The authentication device compares the reported information to determine a degree of environmental similarity for the UEs, and selectively authenticates the UEs as being in a shared environment based on the determined degree of environmental similarity. A given UE among the two or more UEs selects a target UE for performing a given action based on whether the authentication device authenticates the UEs as being in the shared environment.

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which:

FIG. 1 illustrates a high-level system architecture of a wireless communications system in accordance with an embodiment of the invention.

FIG. 2 illustrates examples of user equipments (UEs) in accordance with embodiments of the invention.

FIG. 3 illustrates a communication device that includes logic configured to perform functionality in accordance with an embodiment of the invention.

FIG. 4 illustrates a server in accordance with an embodiment of the invention.

FIGS. 5A and 5B illustrate examples whereby a first UE and a second UE are connected under different operating scenarios in accordance with an embodiment of the invention.

FIG. 6 illustrates a conventional process of transferring call control functions between UEs.

FIG. 7A illustrates a process of selectively selecting a target UE for executing an action based on whether a first UE is authenticated as being in a shared environment with one or more UEs from a set of other UEs in accordance with an embodiment of the invention.

FIG. 7B illustrates a process of authenticating whether two (or more) UEs are in a shared environment in accordance with an embodiment of the invention.

FIGS. 8A-8B illustrate an example implementation of the processes of FIGS. 7A-7B whereby the authentication device corresponds to an authentication server.

FIGS. 9A-9B illustrate another example implementation of the processes of FIGS. 7A-7B whereby the authentication device corresponds to one of the UEs instead of the authentication server.

FIG. 10 illustrates an example implementation of FIGS. 8A-8B in accordance with an embodiment of the invention.

FIG. 11A illustrates an example implementation of FIGS. 8A-8B in accordance with another embodiment of the invention.

FIG. 11B illustrates an example execution environment for the process of FIG. 11A in accordance with an embodiment of the invention.

FIG. 12A illustrates an example implementation of FIGS. 9A-9B in accordance with an embodiment of the invention.

FIG. 12B illustrates an example execution environment for the process of FIG. 12A in accordance with an embodiment of the invention.

FIG. 12C illustrates an example implementation of FIGS. 9A-9B in accordance with another embodiment of the invention.

FIG. 13A illustrates a process of selectively executing obtaining a shared secret key (SSK) at a first UE based on whether the first UE is authenticated as being in a shared environment with a second UE in accordance with an embodiment of the invention.

FIG. 13B illustrates a process of authenticating whether two (or more) UEs are in a shared environment in accordance with an embodiment of the invention.

FIGS. 14A-14C illustrate example implementations of the processes of FIGS. 13A-13B whereby the authentication device corresponds to the authentication server.

FIGS. 15A-15B illustrate another example implementation of the processes of FIGS. 13A-13B whereby the authentication device corresponds to one of the UEs (“UE 2”) instead of the authentication server as in FIGS. 14A-14C.

FIG. 16A illustrates a process whereby an SSK is used for encrypting and decrypting data exchanged between UEs for a current or subsequent connection in accordance with an embodiment of the invention.

FIG. 16B illustrates a process whereby a pre-shared key (PSK) is used for UE authentication for a subsequent connection in accordance with an embodiment of the invention.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A client device, referred to herein as a user equipment (UE), may be mobile or stationary, and may communicate with a radio access network (RAN). As used herein, the term “UE” may be referred to interchangeably as an “access terminal” or “AT”, a “wireless device”, a “subscriber device”, a “subscriber terminal”, a “subscriber station”, a “user terminal” or UT, a “mobile terminal”, a “mobile station” and variations thereof. Generally, UEs can communicate with a core network via the RAN, and through the core network the UEs can be connected with external networks such as the Internet. Of course, other mechanisms of connecting to the core network and/or the Internet are also possible for the UEs, such as over wired access networks, WiFi networks (e.g., based on IEEE 802.11, etc.) and so on. UEs can be embodied by any of a number of types of devices including but not limited to PC cards, compact flash devices, external or internal modems, wireless or wireline phones, and so on. A communication link through which UEs can send signals to the RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

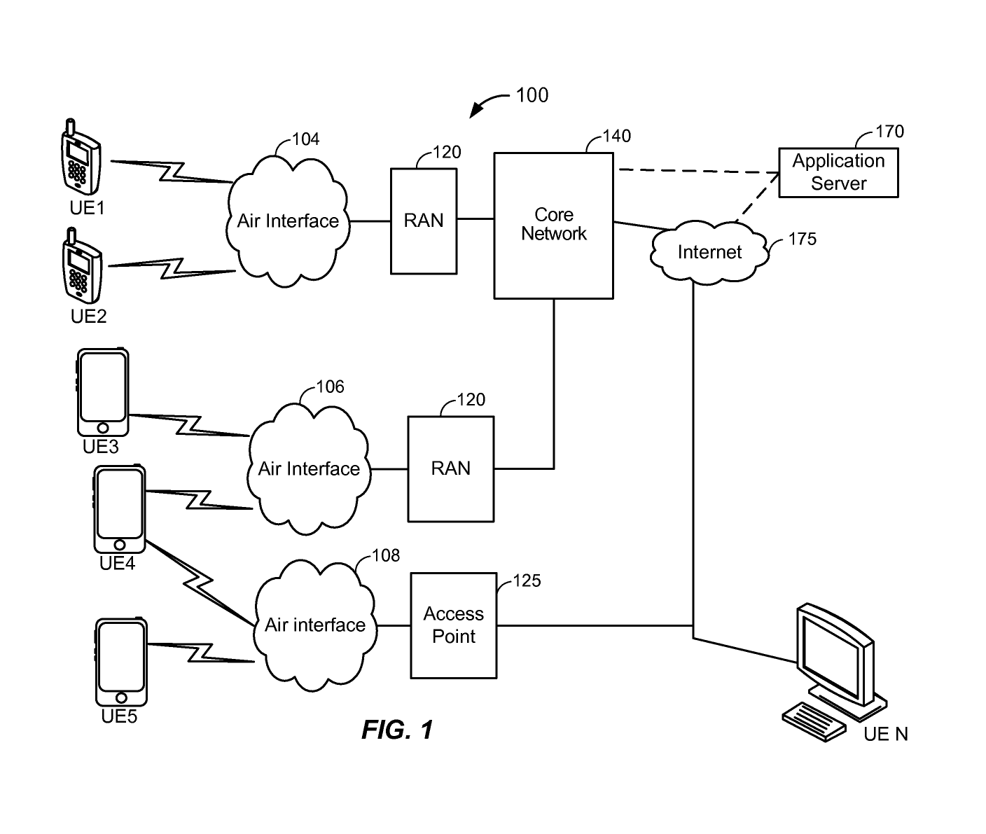

FIG. 1 illustrates a high-level system architecture of a wireless communications system 100 in accordance with an embodiment of the invention. The wireless communications system 100 contains UEs 1 . . . N. The UEs 1 . . . N can include cellular telephones, personal digital assistant (PDAs), pagers, a laptop computer, a desktop computer, and so on. For example, in FIG. 1, UEs 1 . . . 2 are illustrated as cellular calling phones, UEs 3 . . . 5 are illustrated as cellular touchscreen phones or smart phones, and UE N is illustrated as a desktop computer or PC.

Referring to FIG. 1, UEs 1 . . . N are configured to communicate with an access network (e.g., the RAN 120, an access point 125, etc.) over a physical communications interface or layer, shown in FIG. 1 as air interfaces 104, 106, 108 and/or a direct wired connection. The air interfaces 104 and 106 can comply with a given cellular communications protocol (e.g., CDMA, EVDO, eHRPD, GSM, EDGE, W-CDMA, LTE, etc.), while the air interface 108 can comply with a wireless IP protocol (e.g., IEEE 802.11). The RAN 120 includes a plurality of access points that serve UEs over air interfaces, such as the air interfaces 104 and 106. The access points in the RAN 120 can be referred to as access nodes or ANs, access points or APs, base stations or BSs, Node Bs, eNode Bs, and so on. These access points can be terrestrial access points (or ground stations), or satellite access points. The RAN 120 is configured to connect to a core network 140 that can perform a variety of functions, including bridging circuit switched (CS) calls between UEs served by the RAN 120 and other UEs served by the RAN 120 or a different RAN altogether, and can also mediate an exchange of packet-switched (PS) data with external networks such as Internet 175. The Internet 175 includes a number of routing agents and processing agents (not shown in FIG. 1 for the sake of convenience). In FIG. 1, UE N is shown as connecting to the Internet 175 directly (i.e., separate from the core network 140, such as over an Ethernet connection of WiFi or 802.11-based network). The Internet 175 can thereby function to bridge packet-switched data communications between UE N and UEs 1 . . . N via the core network 140. Also shown in FIG. 1 is the access point 125 that is separate from the RAN 120. The access point 125 may be connected to the Internet 175 independent of the core network 140 (e.g., via an optical communication system such as FiOS, a cable modem, etc.). The air interface 108 may serve UE 4 or UE 5 over a local wireless connection, such as IEEE 802.11 in an example. UE N is shown as a desktop computer with a wired connection to the Internet 175, such as a direct connection to a modem or router, which can correspond to the access point 125 itself in an example (e.g., for a WiFi router with both wired and wireless connectivity).

Referring to FIG. 1, a server 170 is shown as connected to the Internet 175, the core network 140, or both. The server 170 can be implemented as a plurality of structurally separate servers, or alternately may correspond to a single server. As will be described below in more detail, the server 170 is configured to support one or more communication services (e.g., Voice-over-Internet Protocol (VoIP) sessions, Push-to-Talk (PTT) sessions, group communication sessions, social networking services, etc.) for UEs that can connect to the server 170 via the core network 140 and/or the Internet 175, and/or to provide content (e.g., web page downloads) to the UEs.

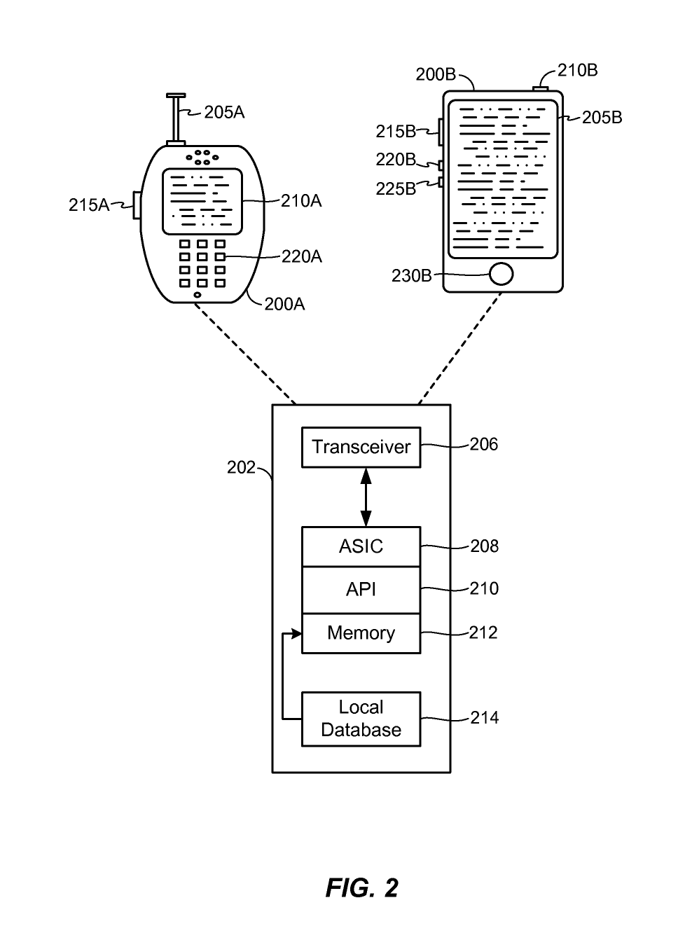

FIG. 2 illustrates examples of UEs (i.e., client devices) in accordance with embodiments of the invention. Referring to FIG. 2, UE 200A is illustrated as a calling telephone and UE 200B is illustrated as a touchscreen device (e.g., a smart phone, a tablet computer, etc.). As shown in FIG. 2, an external casing of UE 200A is configured with an antenna 205A, display 210A, at least one button 215A (e.g., a PTT button, a power button, a volume control button, etc.) and a keypad 220A among other components, as is known in the art. Also, an external casing of UE 200B is configured with a touchscreen display 205B, peripheral buttons 210B, 215B, 220B and 225B (e.g., a power control button, a volume or vibrate control button, an airplane mode toggle button, etc.), at least one front-panel button 230B (e.g., a Home button, etc.), among other components, as is known in the art. While not shown explicitly as part of UE 200B, the UE 200B can include one or more external antennas and/or one or more integrated antennas that are built into the external casing of UE 200B, including but not limited to WiFi antennas, cellular antennas, satellite position system (SPS) antennas (e.g., global positioning system (GPS) antennas), and so on.

While internal components of UEs such as the UEs 200A and 200B can be embodied with different hardware configurations, a basic high-level UE configuration for internal hardware components is shown as platform 202 in FIG. 2. The platform 202 can receive and execute software applications, data and/or commands transmitted from the RAN 120 that may ultimately come from the core network 140, the Internet 175 and/or other remote servers and networks (e.g., application server 170, web URLs, etc.). The platform 202 can also independently execute locally stored applications without RAN interaction. The platform 202 can include a transceiver 206 operably coupled to an application specific integrated circuit (ASIC) 208, or other processor, microprocessor, logic circuit, or other data processing device. The ASIC 208 or other processor executes the application programming interface (API) 210 layer that interfaces with any resident programs in the memory 212 of the wireless device. The memory 212 can be comprised of read-only or random-access memory (RAM and ROM), EEPROM, flash cards, or any memory common to computer platforms. The platform 202 also can include a local database 214 that can store applications not actively used in memory 212, as well as other data. The local database 214 is typically a flash memory cell, but can be any secondary storage device as known in the art, such as magnetic media, EEPROM, optical media, tape, soft or hard disk, or the like.

Accordingly, an embodiment of the invention can include a UE (e.g., UE 200A, 200B, etc.) including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 208, memory 212, API 210 and local database 214 may all be used cooperatively to load, store and execute the various functions disclosed herein and thus the logic to perform these functions may be distributed over various elements. Alternatively, the functionality could be incorporated into one discrete component. Therefore, the features of the UEs 200A and 200B in FIG. 2 are to be considered merely illustrative and the invention is not limited to the illustrated features or arrangement.

The wireless communication between the UEs 200A and/or 200B and the RAN 120 can be based on different technologies, such as CDMA, W-CDMA, time division multiple access (TDMA), frequency division multiple access (FDMA), Orthogonal Frequency Division Multiplexing (OFDM), GSM, or other protocols that may be used in a wireless communications network or a data communications network. As discussed in the foregoing and known in the art, voice transmission and/or data can be transmitted to the UEs from the RAN using a variety of networks and configurations. Accordingly, the illustrations provided herein are not intended to limit the embodiments of the invention and are merely to aid in the description of aspects of embodiments of the invention.

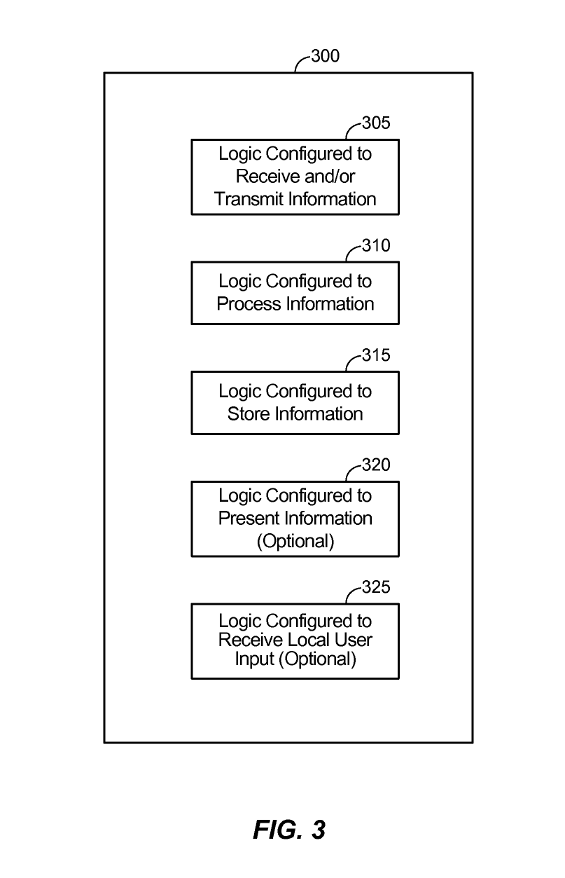

FIG. 3 illustrates a communication device 300 that includes logic configured to perform functionality. The communication device 300 can correspond to any of the above-noted communication devices, including but not limited to UEs 200A or 200B, any component of the RAN 120, any component of the core network 140, any components coupled with the core network 140 and/or the Internet 175 (e.g., the server 170), and so on. Thus, communication device 300 can correspond to any electronic device that is configured to communicate with (or facilitate communication with) one or more other entities over the wireless communications system 100 of FIG. 1.

Referring to FIG. 3, the communication device 300 includes logic configured to receive and/or transmit information 305. In an example, if the communication device 300 corresponds to a wireless communications device (e.g., UE 200A or 200B, AP 125, a BS, Node B or eNodeB in the RAN 120, etc.), the logic configured to receive and/or transmit information 305 can include a wireless communications interface (e.g., Bluetooth, WiFi, 2G, CDMA, W-CDMA, 3G, 4G, LTE, etc.) such as a wireless transceiver and associated hardware (e.g., an RF antenna, a MODEM, a modulator and/or demodulator, etc.). In another example, the logic configured to receive and/or transmit information 305 can correspond to a wired communications interface (e.g., a serial connection, a USB or Firewire connection, an Ethernet connection through which the Internet 175 can be accessed, etc.). Thus, if the communication device 300 corresponds to some type of network-based server (e.g., server 170, etc.), the logic configured to receive and/or transmit information 305 can correspond to an Ethernet card, in an example, that connects the network-based server to other communication entities via an Ethernet protocol. In a further example, the logic configured to receive and/or transmit information 305 can include sensory or measurement hardware by which the communication device 300 can monitor its local environment (e.g., an accelerometer, a temperature sensor, a light sensor, an antenna for monitoring local RF signals, etc.). The logic configured to receive and/or transmit information 305 can also include software that, when executed, permits the associated hardware of the logic configured to receive and/or transmit information 305 to perform its reception and/or transmission function(s). However, the logic configured to receive and/or transmit information 305 does not correspond to software alone, and the logic configured to receive and/or transmit information 305 relies at least in part upon hardware to achieve its functionality.

Referring to FIG. 3, the communication device 300 further includes logic configured to process information 310. In an example, the logic configured to process information 310 can include at least a processor. Example implementations of the type of processing that can be performed by the logic configured to process information 310 includes but is not limited to performing determinations, establishing connections, making selections between different information options, performing evaluations related to data, interacting with sensors coupled to the communication device 300 to perform measurement operations, converting information from one format to another (e.g., between different protocols such as .wmv to .avi, etc.), and so on. For example, the processor included in the logic configured to process information 310 can correspond to a general purpose processor, a digital signal processor (DSP), an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The logic configured to process information 310 can also include software that, when executed, permits the associated hardware of the logic configured to process information 310 to perform its processing function(s). However, the logic configured to process information 310 does not correspond to software alone, and the logic configured to process information 310 relies at least in part upon hardware to achieve its functionality.

Referring to FIG. 3, the communication device 300 further includes logic configured to store information 315. In an example, the logic configured to store information 315 can include at least a non-transitory memory and associated hardware (e.g., a memory controller, etc.). For example, the non-transitory memory included in the logic configured to store information 315 can correspond to RAM memory, flash memory, ROM memory, EPROM memory, EEPROM memory, registers, hard disk, a removable disk, a CD-ROM, or any other form of storage medium known in the art. The logic configured to store information 315 can also include software that, when executed, permits the associated hardware of the logic configured to store information 315 to perform its storage function(s). However, the logic configured to store information 315 does not correspond to software alone, and the logic configured to store information 315 relies at least in part upon hardware to achieve its functionality.

Referring to FIG. 3, the communication device 300 further optionally includes logic configured to present information 320. In an example, the logic configured to present information 320 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 300. For example, if the communication device 300 corresponds to UE 200A or UE 200B as shown in FIG. 2, the logic configured to present information 320 can include the display 210A of UE 200A or the touchscreen display 205B of UE 200B. In a further example, the logic configured to present information 320 can be omitted for certain communication devices, such as network communication devices that do not have a local user (e.g., network switches or routers, remote servers such as the server 170, etc.). The logic configured to present information 320 can also include software that, when executed, permits the associated hardware of the logic configured to present information 320 to perform its presentation function(s). However, the logic configured to present information 320 does not correspond to software alone, and the logic configured to present information 320 relies at least in part upon hardware to achieve its functionality.

Referring to FIG. 3, the communication device 300 further optionally includes logic configured to receive local user input 325. In an example, the logic configured to receive local user input 325 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communication device 300. For example, if the communication device 300 corresponds to UE 200A or UE 200B as shown in FIG. 2, the logic configured to receive local user input 325 can include the keypad 220A, any of the buttons 215A or 210B through 225B, the touchscreen display 205B, etc. In a further example, the logic configured to receive local user input 325 can be omitted for certain communication devices, such as network communication devices that do not have a local user (e.g., network switches or routers, remote servers such as the server 170, etc.). The logic configured to receive local user input 325 can also include software that, when executed, permits the associated hardware of the logic configured to receive local user input 325 to perform its input reception function(s). However, the logic configured to receive local user input 325 does not correspond to software alone, and the logic configured to receive local user input 325 relies at least in part upon hardware to achieve its functionality.

Referring to FIG. 3, while the configured logics of 305 through 325 are shown as separate or distinct blocks in FIG. 3, it will be appreciated that the hardware and/or software by which the respective configured logic performs its functionality can overlap in part. For example, any software used to facilitate the functionality of the configured logics of 305 through 325 can be stored in the non-transitory memory associated with the logic configured to store information 315, such that the configured logics of 305 through 325 each performs their functionality (i.e., in this case, software execution) based in part upon the operation of software stored by the logic configured to store information 315. Likewise, hardware that is directly associated with one of the configured logics can be borrowed or used by other configured logics from time to time. For example, the processor of the logic configured to process information 310 can format data into an appropriate format before being transmitted by the logic configured to receive and/or transmit information 305, such that the logic configured to receive and/or transmit information 305 performs its functionality (i.e., in this case, transmission of data) based in part upon the operation of hardware (i.e., the processor) associated with the logic configured to process information 310.

Generally, unless stated otherwise explicitly, the phrase “logic configured to” as used throughout this disclosure is intended to invoke an embodiment that is at least partially implemented with hardware, and is not intended to map to software-only implementations that are independent of hardware. Also, it will be appreciated that the configured logic or “logic configured to” in the various blocks are not limited to specific logic gates or elements, but generally refer to the ability to perform the functionality described herein (either via hardware or a combination of hardware and software). Thus, the configured logics or “logic configured to” as illustrated in the various blocks are not necessarily implemented as logic gates or logic elements despite sharing the word “logic.” Other interactions or cooperation between the logic in the various blocks will become clear to one of ordinary skill in the art from a review of the embodiments described below in more detail.

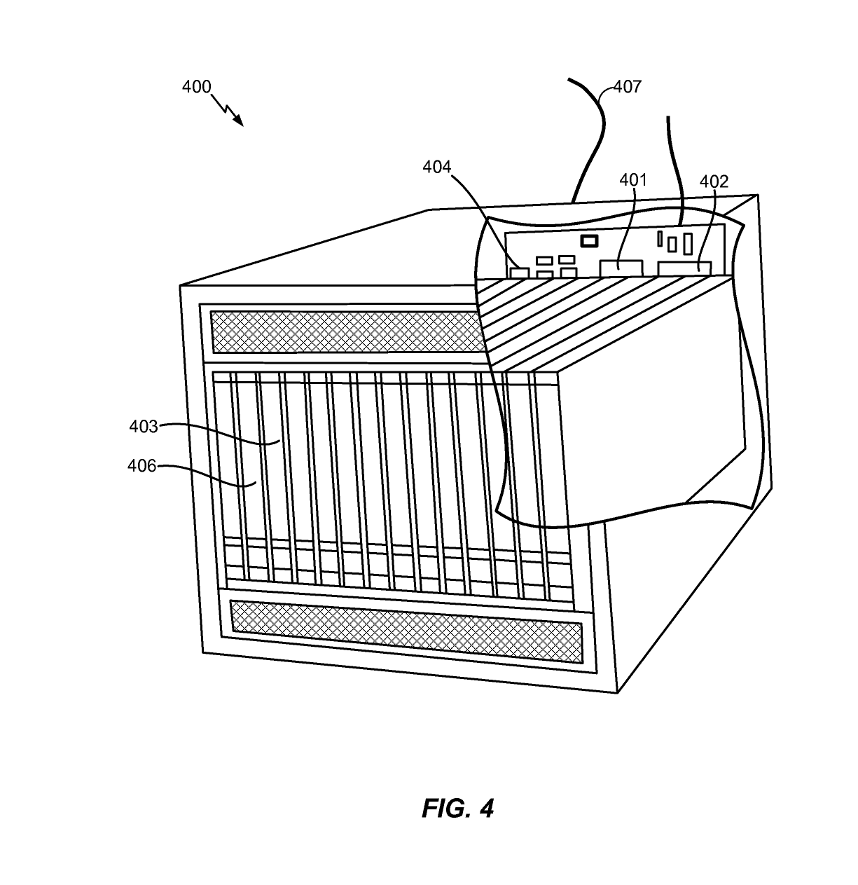

The various embodiments may be implemented on any of a variety of commercially available server devices, such as server 400 illustrated in FIG. 4. In an example, the server 400 may correspond to one example configuration of the application server 170 described above. In FIG. 4, the server 400 includes a processor 400 coupled to volatile memory 402 and a large capacity nonvolatile memory, such as a disk drive 403. The server 400 may also include a floppy disc drive, compact disc (CD) or DVD disc drive 406 coupled to the processor 401. The server 400 may also include network access ports 404 coupled to the processor 401 for establishing data connections with a network 407, such as a local area network coupled to other broadcast system computers and servers or to the Internet. In context with FIG. 3, it will be appreciated that the server 400 of FIG. 4 illustrates one example implementation of the communication device 300, whereby the logic configured to transmit and/or receive information 305 corresponds to the network access ports 304 used by the server 400 to communicate with the network 407, the logic configured to process information 310 corresponds to the processor 401, and the logic configuration to store information 315 corresponds to any combination of the volatile memory 402, the disk drive 403 and/or the disc drive 406. The optional logic configured to present information 320 and the optional logic configured to receive local user input 325 are not shown explicitly in FIG. 4 and may or may not be included therein. Thus, FIG. 4 helps to demonstrate that the communication device 300 may be implemented as a server, in addition to a UE implementation as in 205A or 205B as in FIG. 2.

User equipments (UEs) such as telephones, tablet computers, laptop and desktop computers, certain vehicles, etc., can be configured to connect with each other either locally (e.g., Bluetooth, local WiFi, etc.) or remotely (e.g., via cellular networks, through the Internet, etc.). Connection establishment between UEs can sometimes trigger actions by one or more of the connected UEs. For example, an operator may be engaged in a telephone call via a Bluetooth-equipped handset while approaching his/her vehicle when the operator decides to trigger a remote start of the vehicle. In this case, the operator is not yet actually inside of the vehicle, but certain actions such as transferring call functions from the handset to the vehicle may be triggered automatically, which can frustrate the operator and degrade user experience for the call (e.g., the handset stops capturing and/or playing call audio and the vehicle starts capturing and playing call audio when the operator is not even in the car yet). Thereby, merely identifying proximity or connection establishment is not necessarily sufficient to conclude that two UEs are operating in a shared environment.

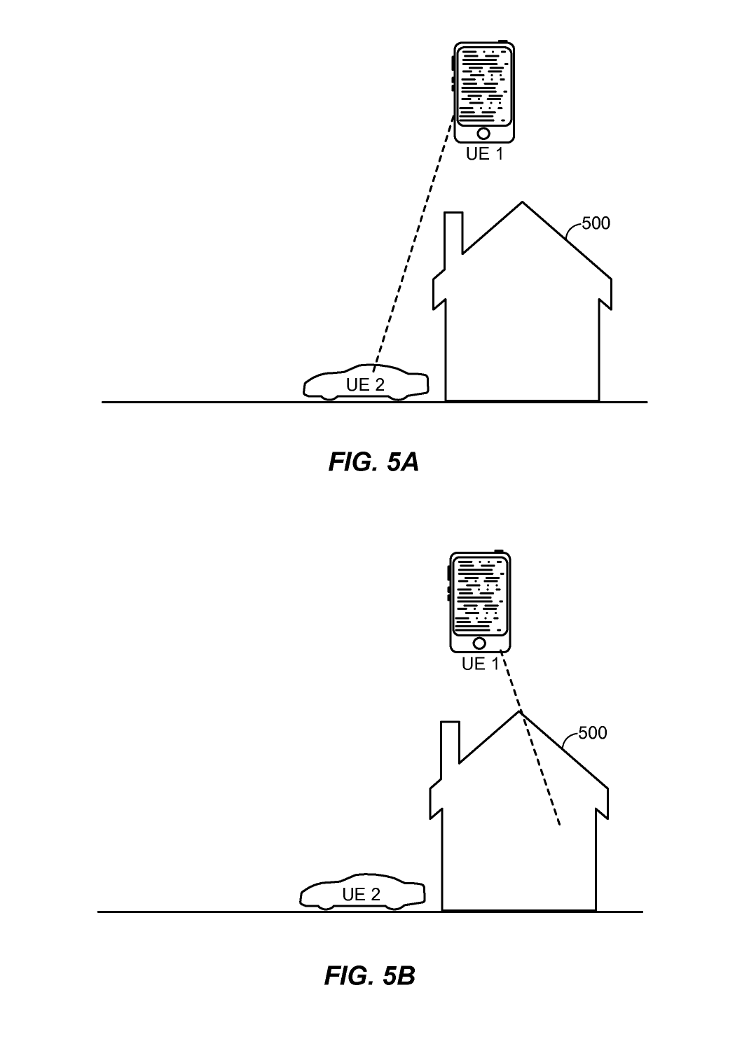

FIGS. 5A and 5B illustrate examples whereby a first UE (“UE 1”) and a second UE (“UE 2”) are connected under different operating scenarios in accordance with an embodiment of the invention. In FIGS. 5A and 5B, UE 1 corresponds to a handset device (e.g., a cellular telephone, a tablet computer, etc.) equipped with Bluetooth and UE 2 corresponds to a control system for a Bluetooth-equipped vehicle, whereby both UE 1 and UE 2 are positioned in proximity to a house 500 (e.g., the vehicle can be parked in the house's driveway). For convenience of explanation, assume that the operator of UE 1 has previously paired UE 1 with UE 2, such that UEs 1 and 2 will automatically connect when UEs 1 and 2 are powered-on with Bluetooth enabled and are in-range of each other. In FIG. 5A, UE 1 is physically inside of the vehicle, while in FIG. 5B, UE 1 is inside the house 500 but is close enough to UE 2 for a Bluetooth connection as well as other remote functions (e.g., remote-start, remotely unlocking or locking the vehicle, etc.).

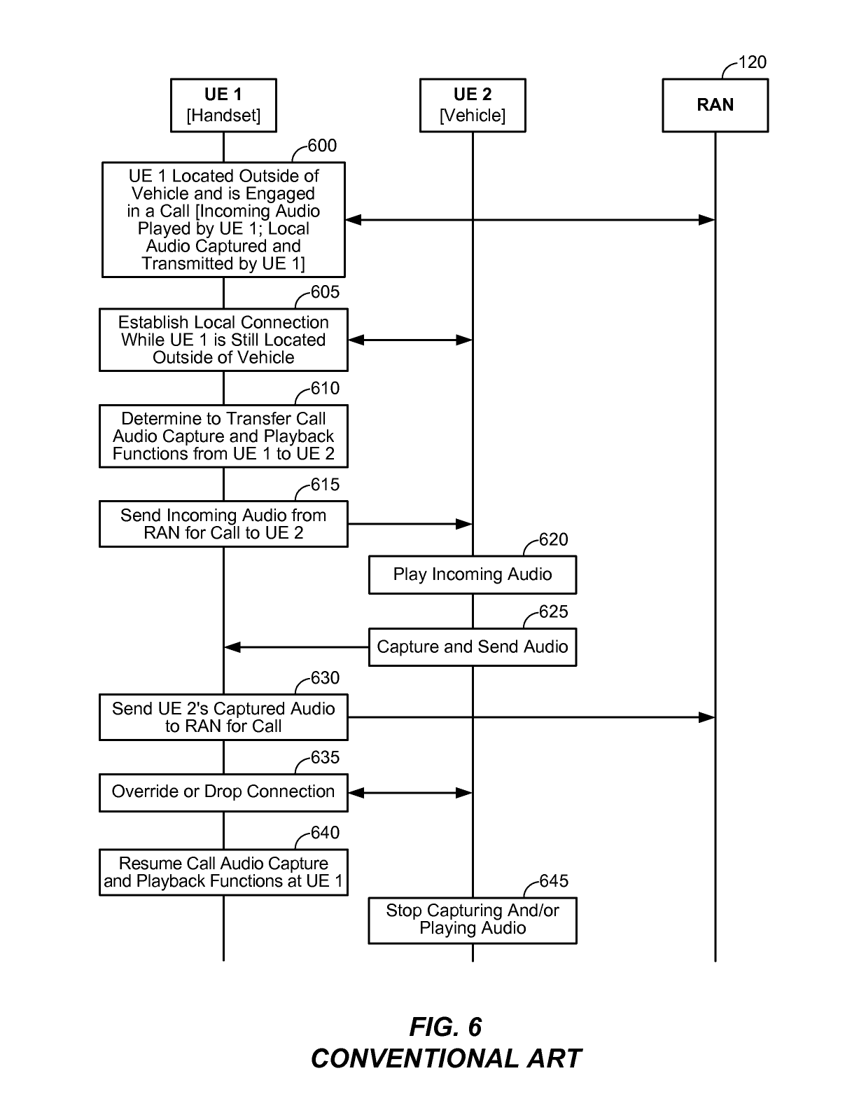

FIG. 6 illustrates a conventional process of transferring call control functions from UE 1 to UE 2. Referring to FIG. 6, assume that UEs 1 and 2 are positioned as shown in FIG. 5B, whereby the operator of UE 1 is inside the house 500 and is not physically inside of the vehicle with UE 1, 600. Further assume at 600 that the operator is actively engaged in a phone call via UE 1, such that UE 1 receives incoming audio for the call and plays the incoming audio via its speakers, and UE 1 captures local audio (e.g., the speech of the operator) and transmits the locally captured audio to the RAN 120 for delivery to one or more other call participant(s).

At some point during the call, a local connection (e.g., a Bluetooth connection) is established between UE 1 and UE 2, 605. For example, the operator of UE 1 may be inside the house 500 while his/her spouse starts up the vehicle or arrives at the house 500 with the vehicle, which triggers the connection establishment at 605. In another example, the operator of UE 1 may be inside the house 500 when the operator him/herself decides to remote-start the vehicle (e.g., to set the temperature in the vehicle to a desired level before a trip, etc.), which triggers the connection establishment at 605.

In FIG. 6, the establishment of the local connection at 605 is configured to automatically transfer call control functions associated with audio capture and playback from UE 1 to UE 2, 610. Thereby, UE 1 begins to stream incoming audio from the RAN 120 to UE 2 for playback via the vehicle's speaker(s), 615, and UE 2 receives the audio and outputs the audio via the vehicle's speaker(s), 620. Also, UE 2 begins to capture audio from inside the vehicle via the vehicle's microphone(s), 625, which is then streamed to UE 1 for transmission to the other call participant(s) via the RAN 120, 630.

Eventually, the undesirable transfer of the call control functions from UE 1 to UE 2 is terminated, either via an operator-specified override at UE 1 or via termination of the local connection, 635 (e.g., the local connection can be lost when the vehicle is turned off, when the vehicle begins to drive away from the house 500, etc.). At this point, UE 1 can resume audio capture and playback functions, 640, and UE 2 stops capturing and/or playing audio for the call on behalf of UE 1, 645.

As will be appreciated, establishment of a local connection can be useful in many cases to trigger operations based on the presumed proximity of the connected UEs. However, as shown in FIG. 6, there are instances where connected UEs, while close, do not share the same environment, such that automatically performing certain actions (e.g., such as transferring call control functions, transferring a speaker output function, transferring a video presentation function, etc.) does not make sense in context despite the connection establishment. For these reasons, embodiments of the invention relate to using a degree to which local ambient sounds at the connected UEs are similar to authenticate whether or not the connected UEs are operating in the same, shared environment.

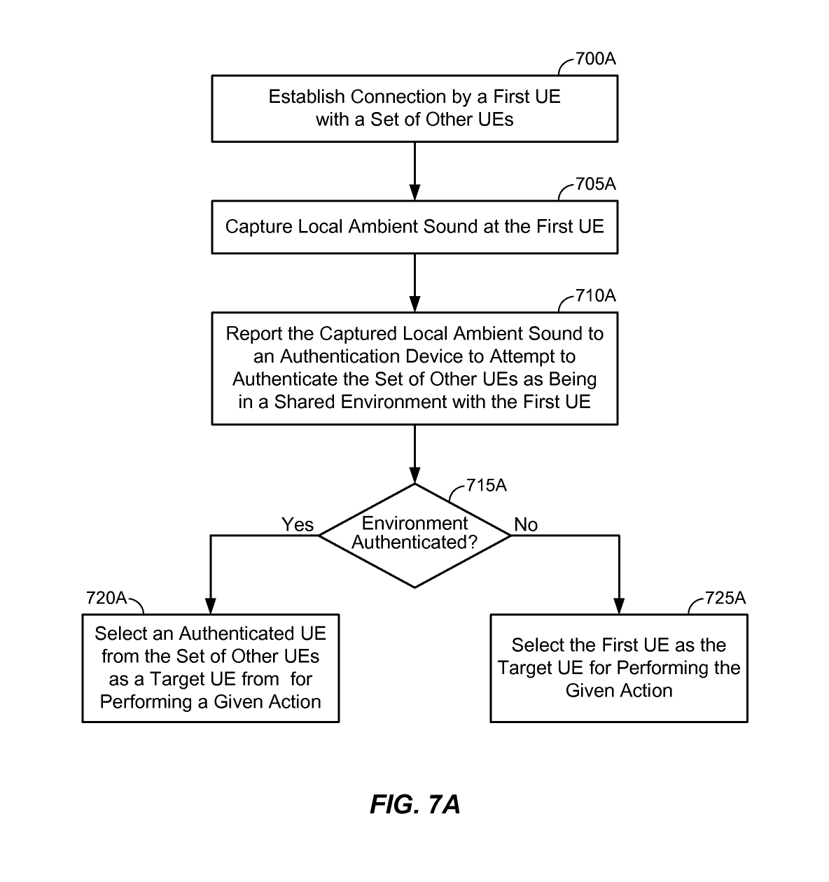

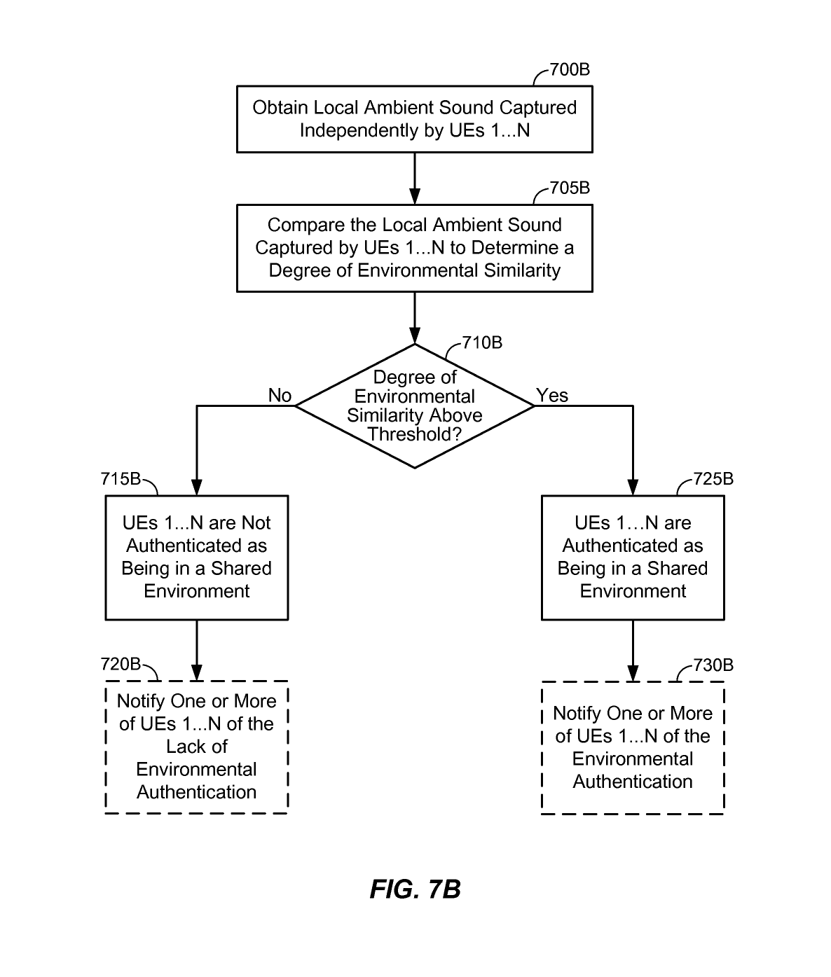

FIG. 7A illustrates a process of selectively selecting a target UE for executing an action based on whether a first UE is authenticated as being in a shared environment with one or more UEs from a set of other UEs in accordance with an embodiment of the invention.

Referring to FIG. 7A, the first UE establishes one or more connections with the set of other UEs including, 700A. In an example, the connection(s) established at 700A can correspond to a set of local peer-to-peer (P2P) wireless connections between the respective UEs. However, in other embodiments connection(s) established at 700A can either be a local connection (e.g., Bluetooth, etc.), or a remote connection (e.g., over a network such as RAN 120 or the Internet 175). In an example, the set of other UEs can include a single UE, or can include multiple UEs. While connected to the set of other UE, the first UE captures local ambient sound, 705A. In particular, the sound capture at 705A specifically targets ambient sound that could not be mimicked or spoofed by UEs that do not share the same environment. For example, if a sound emitting device emitted a pre-defined beacon and environmental authentication was conditioned upon detection of the pre-defined beacon (e.g., an audio code or signature, etc.) within a particular sound recording, it will be appreciated that the environmental authentication would be compromised whenever the beacon is compromised, i.e., a third party that is not in the same environment could simply add the beacon to its sound recording and be authenticated. By contrast, simply capturing ambient sound without attempting to deliberately insert a code or beacon into the environment for use in environmental detection is more reliable because there is no mere code or beacon that can be compromised by a potential hacker prior to the audio capture.

In a further example, the sound capture at 705A can be implemented by one or more microphones coupled to the first UE (e.g., such as 325 from FIG. 3). For example, UEs such as handsets, tablet computers and so on typically have integrated microphones, UEs that run control systems on vehicles typically have microphones near the driver's seat (at least), and so on. Once captured, the local ambient sound from 705A is reported to an authentication device in order to attempt to authenticate the set of other UEs as being in the same shared environment as the first UE, 710A. In an example, the local ambient sound that is reported at 710A can correspond to an actual sound signature that is captured by the first UE's microphone at 705A. However, in an alternative example, the local ambient sound that is reported at 710A can correspond to information that is extracted or processed from the actual sound signature that is captured by the first UE's microphone at 705A. For example, speech can be captured at 705A, and the first UE can convert the speech to text and then transmit the text at 710A. For example, speech can be captured at 705A, and the first UE can identify the speaker based on his/her audio characteristics and then report an identity of the speaker at 710A. In another example, sound captured at 705A can be filtered in some manner and the filtered sound can be transmitted at 710A. In another example, the sound captured at 705A can be converted into an audio signature (e.g., a fingerprint, a spectral information classification, an identification of a specific user that is speaking based on his/her speech characteristics), or can be classified in some other manner (e.g., concert environment, specific media (e.g., a song, TV show, movie, etc.) playing in the background can be identified, etc.). Thus, if the specific media is identified as a song from a specific album is playing in the background during the sound capture of 705A, information associated with that specific song (e.g., title, album, artist, etc.) can be reported at 710A. These examples thereby demonstrate that the report of 710A does not need to simply be a forwarding of the ‘raw’ sound captured at 705A, but can alternatively simply be descriptive of the sound captured at 705A in some manner. Thereby, any reference to a report or exchange of locally captured ambient sound is intended to cover either a report or exchange of the ‘raw’ sound or audio, or a report of any information that is gleaned or extracted from the ‘raw’ sound or audio. Also, if the ‘raw’ sound captured at 705A is reported at 710A, the authentication device itself could implement logic to convert the raw reported sound into a useable format, such as an audio signature or other audio classification, which can then be compared against audio signatures and/or classifications of other UE environments to determine a degree of similarity.

In FIG. 7A, the authentication device can correspond to a remote server in an example (e.g., such as application server 170), or the authentication device can correspond to one of the connected UEs. If the authentication device corresponds to a second UE from the set of one or more other UEs, the first UE can stream the locally captured ambient sound to the second UE over the connection from 700A to attempt authentication, in an example. If the authentication device corresponds to the first UE itself, the reporting that occurs at 710A can be an internal operation whereby the locally captured ambient sound from 705A is passed or made available to a client application executing on the first UE which is configured to evaluate and compare sound signatures.

Referring to FIG. 7A, the first UE determines whether it has been authenticated as being in the shared environment with any of the set of other UEs at 715A in order to select a target UE from a plurality of candidate UEs (e.g., the first UE itself plus the set of other UEs) for performing a given action (e.g., for handling audio output and audio capture for a voice call). For example, if the first UE itself is the authentication device, the determination of 715A can correspond to a self-determination of authentication. In another example, if the second UE or the remote server is the authentication device, the determination of 715A can be based on whether the first UE receives a notification from the authentication device indicating that the first UE is authenticated as being in the shared environment with any of the set of other UEs. At 715A, a lack of authentication can be determined by the first UE either via an explicit notification from the authentication device regarding the non-authentication, or based on a failure of the authentication device to affirmatively authenticate the respective UEs as being in the shared environment.

If the first UE determines that the first UE and at least one UE from the set of other UEs are authenticated as being within the shared environment at 715A, then the first UE selects one of the authenticated UEs from the set of other UEs as the target UE for performing the given action, 720A. Using the example from FIG. 6, if the given action is handling a call control function, the authenticated UE selected at 720A can correspond to a vehicle audio system selected to perform the call control function if the first UE is inside of the vehicle. Other examples of the given action will be described below in more detail. Otherwise, if the first UE determines that the first and the set of other UEs are not authenticated as being within the shared environment at 715A, the first UE selects itself as the target UE based on the lack of authentication, 725A. Using the example from FIG. 6, if the given action is handling a call control function at 725A, the first UE can select itself so as to maintain the call control function without passing the call control function to a vehicle audio system if the first UE is not inside of the vehicle.

It will be appreciated in FIG. 7A that the set of other UEs can include a single UE or multiple UEs. In the case where the connection established at 700A is between a larger group of UEs, the first UE is trying to authenticate whether it is in a shared environment with any (or all) of the other UEs in the group.

FIG. 7B illustrates a process of authenticating whether two (or more) UEs are in a shared environment in accordance with an embodiment of the invention. Referring to FIG. 7B, an authentication device obtains local ambient sound that was captured independently at each of UEs 1 . . . N, 700B. For example, the local ambient sound obtained at 700B can be captured by UEs 1 . . . N while UEs 1 . . . N are each connected via one or more local P2P connections. If the authentication device corresponds to one of UEs 1 . . . N, the local ambient sound may be received over a local or remote connection established with the other UEs. If the authentication device corresponds to a remote server, each of UEs 1 . . . N may deliver their respective locally captured ambient sound thereto via a remote connection such as the RAN 120, the Internet 175, and so on.

Referring to FIG. 7B, the authentication device compares the local ambient sound captured at each of UEs 1 . . . N to determine a degree of environmental similarity, 705B. As will be appreciated, the sound captured by UEs that are right next to each other will still have differences despite their close proximity, due to microphone quality disparity, microphone orientation, how close each UE is to a speaker or sound source, and so on. However, a threshold can be established to identify whether the respective environments of the UEs are adequately shared (or comparable) from an operational perspective. For example, the threshold can be configured so that UEs inside of a vehicle (of varying microphone qualities and positions within the vehicle) will have a degree of similarity that exceeds the threshold, while a UE outside of the vehicle when the doors of the vehicles are closed would capture a muffled version of the sound inside the car and would thereby have a degree of similarity with a UE inside the car that is not above the threshold.

Also, different thresholds can be established for different use cases. For example, remote UEs that are tuned to the same telephone call or watching the same TV show can be allocated a threshold so that, even though the remote UEs are in different locations and are capturing sound emitted from different speaker types and positions relative to the UEs, their environments can be deemed as shared based on the commonality of the audio being output therein (e.g., the telephone call or TV show may be played at different volumes by different speaker systems, so the threshold can weight content of audio over audio volume if the authentication device wishes to authenticate remote devices that are tuned to the same telephone call or TV show). Accordingly, the concept of a “shared environment” is intended to be interpreted broadly, and can vary between implementations. Thereby, any set of environments that have similar contemporaneous sound characteristics can potentially qualify as a shared environment, even if the UEs capturing their respective environments are far away from each other, capture their environments at different degrees of precision or at different volumes, and so on. The shared environment is thereby sufficient to infer that the UEs are engaged in a real-time or contemporaneous session with similar audio characteristics.

Generally, the shared environment will have similar audio characteristics that are aligned by time. For example, even through their respective sound environments will be similar, a user watching a TV show at 8 PM is not in a shared environment with another user that watches a re-run (or DVRed version) of the TV show at 10 PM. Similarly, a user listening to an archived version of a telephone call is not in a shared environment of users that were actively engaged in that telephone call in real-time.

Referring to FIG. 7B, the authentication device determines whether the degree of environmental similarity is above the threshold at 710B. If not, the authentication device determines that UEs 1 . . . N are not authenticated as being in a shared environment, 715B, and the authentication device can optionally notify one or more of UEs 1 . . . N regarding the lack of environmental authentication, 720B. Otherwise, if the authentication device determines that the degree of environmental similarity is above the threshold at 710B, the authentication device determines that UEs 1 . . . N are authenticated as being in a shared environment, 725B, and the authentication device can optionally notify one or more of UEs 1 . . . N regarding the lack of environmental authentication, 730B. The notification of 730B is optional because in a scenario where the authentication device corresponds to one of UEs 1 . . . N, the authentication device can execute the action as in 720A of FIG. 7A without explicitly notifying the other UEs regarding the environmental authentication.

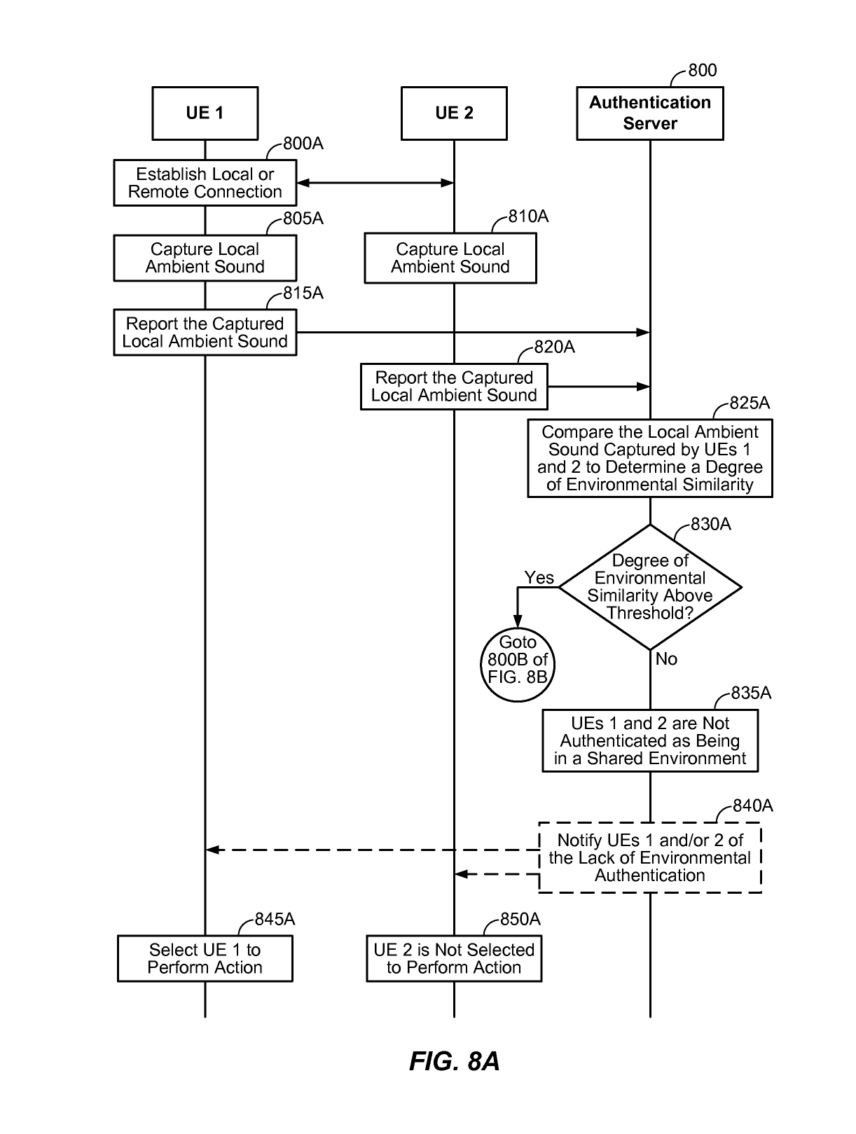

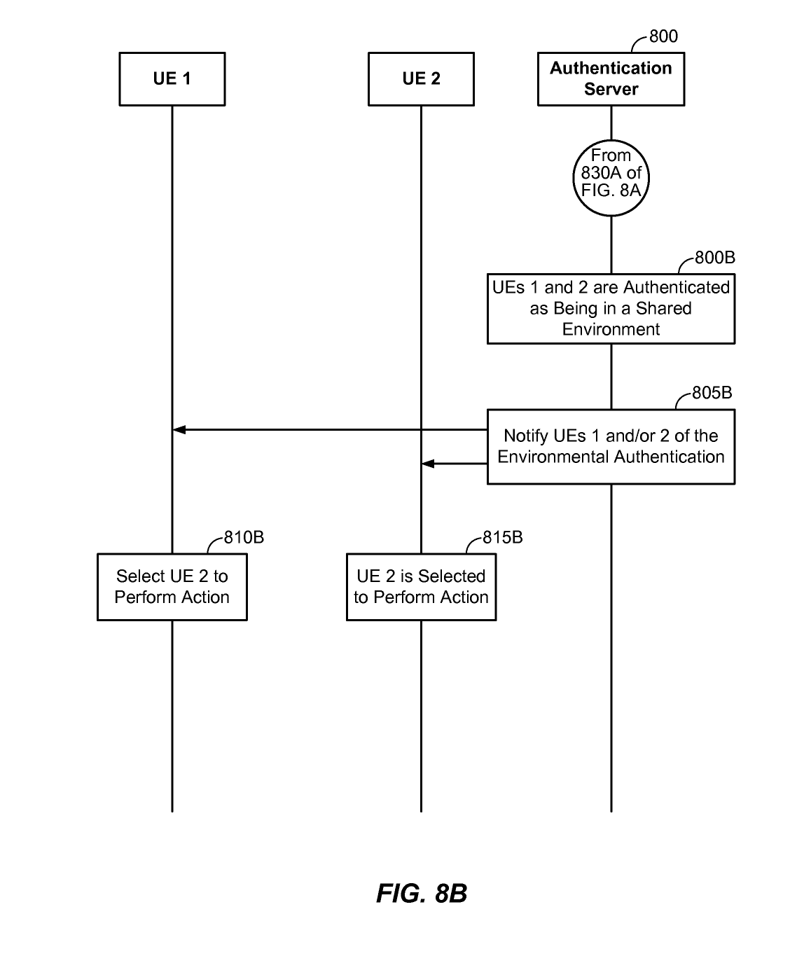

FIGS. 8A-8B illustrate an example implementation of the processes of FIGS. 7A-7B whereby the authentication device corresponds to an authentication server 800. In FIGS. 8A-8B, the set of other UEs from FIG. 7A corresponds to UE 2 as if the set of other UEs included a single UE, although it will be appreciated that the set of other UEs could include multiple UEs in other embodiments of the invention. Referring to FIG. 8A, UEs 1 and 2 establish either a local or remote connection, 800A (e.g., as in 700A of FIG. 7A), and UEs 1 and 2 then capture local ambient sound, 805A and 810A (e.g., as in 705A of FIG. 7A). UEs 1 and 2 report their respective locally captured ambient sound to the authentication server 800 (e.g., via the RAN 120 or some other connection), 815A and 820A (e.g., as in 710A of FIG. 7A or 700B of FIG. 7B). The authentication server 800 compares the locally captured local ambient sound reported by UE 1 at 815A with the locally captured local ambient sound reported by UE 2 at 820A to determine a degree of environmental similarity for UEs 1 and 2, 825A (e.g., as in 705B of FIG. 7B), after which the authentication server 800 determines whether the determined degree of similarity is above a threshold, 830A (e.g., as in 710B of FIG. 7B). If the determined degree of similarity is determined not to be above the threshold at 830A, the authentication server 800 does not authenticate UEs 1 and 2 as being in the shared environment, 835A (e.g., as in 715B of FIG. 7B), and the authentication server 800 can optionally notify UEs 1 and 2 regarding the lack of environmental authentication, 840A (e.g., as in 720B of FIG. 7B). UEs 1 and/or 2 determine that their respective environments are not authenticated as a shared environment and thereby UE 1 is selected to perform the given action (e.g., a call control function, a speaker output function, a video presentation function, etc.), 845A, and UE 2 is not selected to perform the given action, 850A (e.g., as in 715A and 725A of FIG. 7A)

Returning to 830A, if the determined degree of similarity is determined to be above the threshold, the process advances to FIG. 8B whereby the authentication server 800 authenticates UEs 1 and 2 as being in the shared environment, 800B (e.g., as in 725B of FIG. 7B), and the authentication server 800 notifies UEs 1 and 2 regarding the environmental authentication, 805B (e.g., as in 730B of FIG. 7B). UEs 1 and 2 determine that their respective environments are authenticated as a shared environment and thereby UE 1 selects UE 2 as the target UE to perform the given action based on the environmental authentication, 810B and 815B (e.g., as in 715A and 720A of FIG. 7A). As will be appreciated, if the set of other UEs included multiple UEs instead of merely UE 2 and two or more of the multiple UEs were authenticated as being in the shared environment with UE 1, UE 1 could execute a target UE selection policy to select a single target UE from the multiple authenticated UEs or alternatively could execute the target UE selection policy to select more than one of the multiple authenticated UEs for performing some portion of the given action (e.g., if the given action is to play music, two or more authenticated speaker-UEs could be selected in one example).

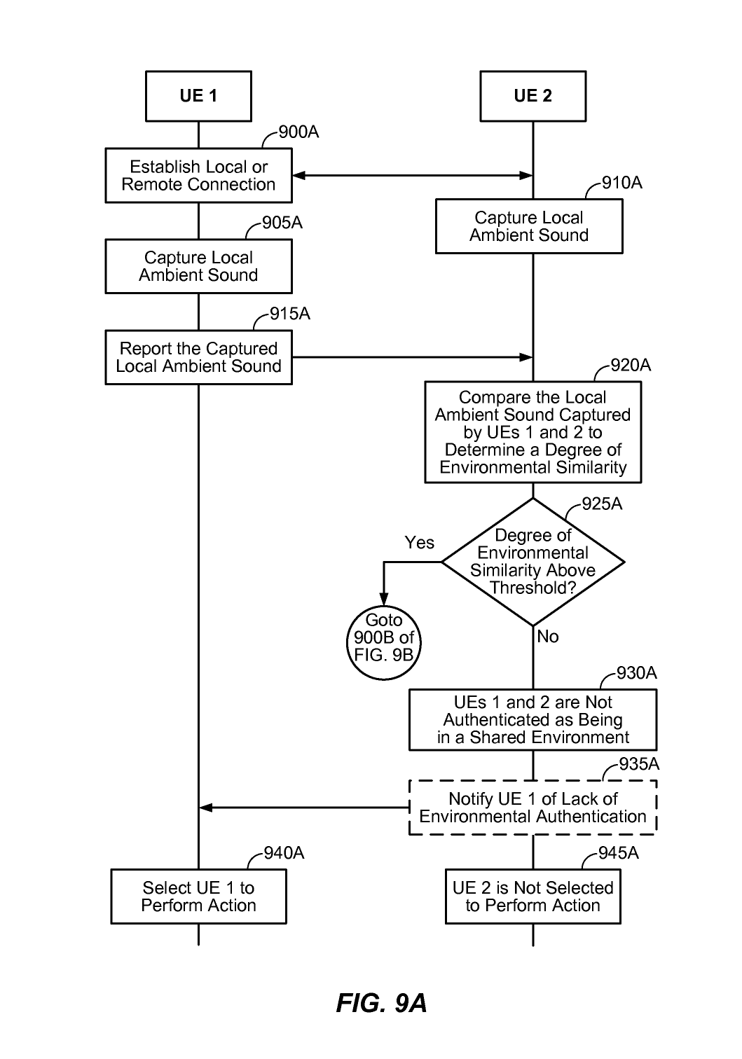

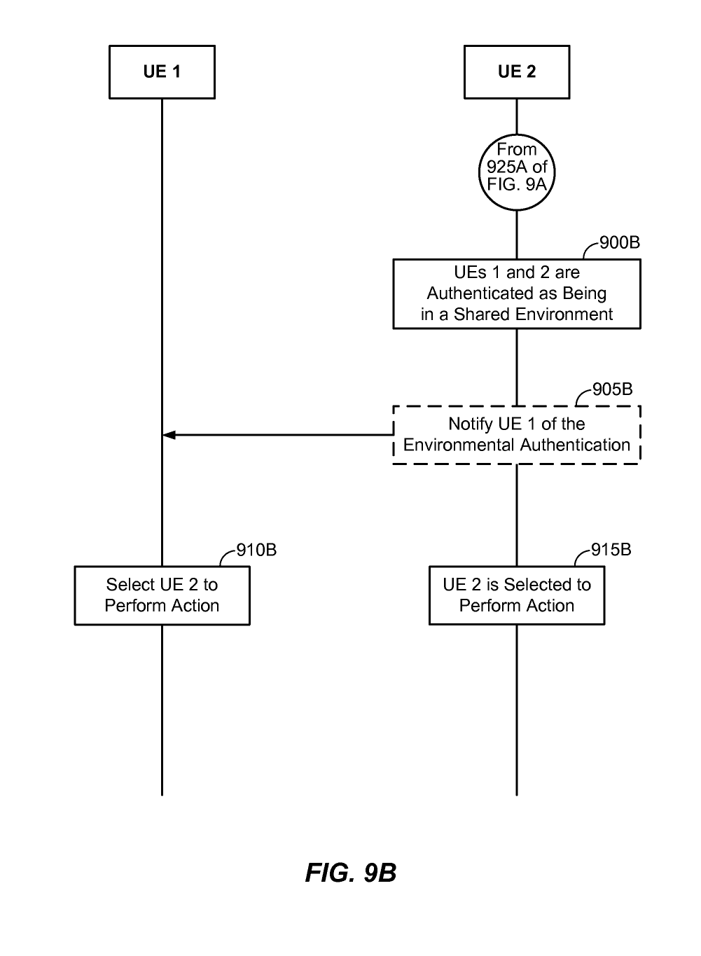

FIGS. 9A-9B illustrate another example implementation of the processes of FIGS. 7A-7B whereby the authentication device corresponds to one of the UEs (“UE 2”) instead of the authentication server 800 as in FIGS. 8A-8B. Similar to FIGS. 8A-8B, the set of other UEs from FIG. 7A corresponds to UE 2 as if the set of other UEs included a single UE, although it will be appreciated that the set of other UEs could include multiple UEs in other embodiments of the invention. Referring to FIG. 9A, UEs 1 and 2 establish either a local or remote connection, 900A (e.g., as in 700A of FIG. 7A), and UEs 1 and 2 then capture local ambient sound, 905A and 910A (e.g., as in 705A of FIG. 7A). UE 1 reports its locally captured ambient sound to UE 2 (e.g., over the connection established at 900A in an example), 915A (e.g., as in 710A of FIG. 7A or 700B of FIG. 7B). UE 2 compares the locally captured local ambient sound reported by UE 1 (915A) with the local ambient sound captured by UE 2 (910A) to determine a degree of environmental similarity for UEs 1 and 2, 920A (e.g., as in 705B of FIG. 7B), after which UE 2 determines whether the determined degree of similarity is above a threshold, 925A (e.g., as in 710B of FIG. 7B). If the determined degree of similarity is determined not to be above the threshold at 925A, UE 2 does not authenticate UEs 1 and 2 as being in the shared environment, 930A (e.g., as in 715B of FIG. 7B), UE 2 can optionally notify UE 1 regarding the lack of environmental authentication, 935A (e.g., as in 720B of FIG. 7B). UEs 1 and 2 determine that their respective environments are not authenticated as a shared environment and thereby UE 1 is selected to perform the given action (e.g., a call control function, a speaker output function, a video presentation function, etc.), 940A, and UE 2 is not selected to perform the given action, 945A (e.g., as in 715A and 725A of FIG. 7A).

Returning to 925A, if the determined degree of similarity is determined to be above the threshold, the process advances to FIG. 9B whereby UE 2 authenticates UEs 1 and 2 as being in the shared environment, 900B (e.g., as in 725B of FIG. 7B), and UE 2 optionally notifies UE 1 regarding the environmental authentication, 905B (e.g., as in 730B of FIG. 7B). UEs 1 and 2 determine that their respective environments are authenticated as a shared environment and thereby UE 1 selects UE 2 as the target UE to perform the given action, 910B and 915B (e.g., as in 715A and 720A of FIG. 7A).

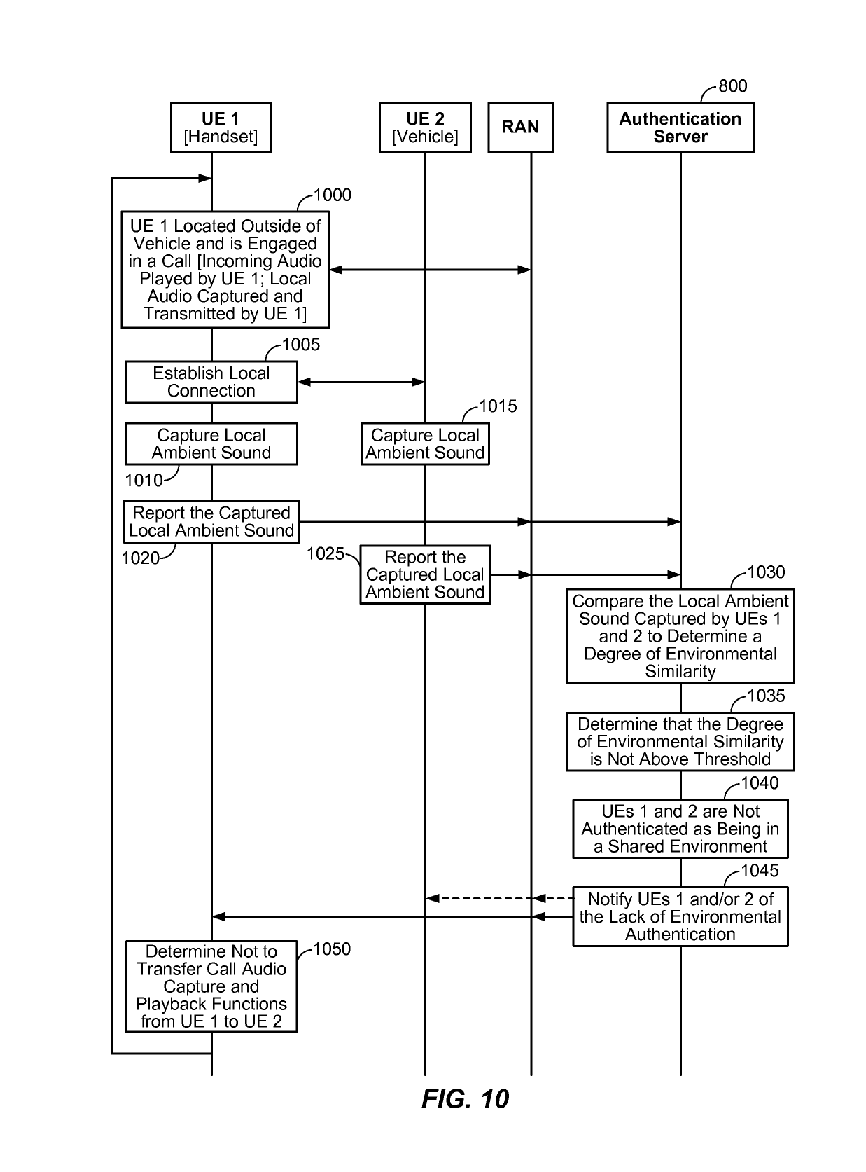

FIG. 10 illustrates an example implementation of FIGS. 8A-8B in accordance with an embodiment of the invention. Similar to FIGS. 8A-9B, the set of other UEs from FIG. 7A corresponds to UE 2 as if the set of other UEs included a single UE, although it will be appreciated that the set of other UEs could include multiple UEs in other embodiments of the invention. In FIG. 10, similar to FIG. 6, assume that UEs 1 and 2 are positioned as shown in FIG. 5B, whereby the operator of UE 1 is inside the house 500 and is not physically inside of the vehicle with UE 1, 1000. Further assume at 1000 that the operator is actively engaged in a phone call via UE 1, such that UE 1 receives incoming audio for the call and plays the incoming audio via its speakers, and UE 1 captures local audio (e.g., the speech of the operator) and transmits the locally captured audio to the RAN 120 for delivery to one or more other call participant(s).

At some point during the call, UEs 1 and 2 establish a local connection (e.g., a Bluetooth connection), 1005 (e.g., as in 800A of FIG. 8A). For example, the operator of UE 1 may be inside the house 500 while his/her spouse starts up the vehicle or arrives at the house 500 with the vehicle, which triggers the connection establishment at 1005. In another example, the operator of UE 1 may be inside the house 500 when the operator him/herself decides to remote-start the vehicle (e.g., to set the temperature in the vehicle to a desired level before a trip, etc.), which triggers the connection establishment at 1005.

At this point, instead of automatically transferring call control functions associated with audio capture and playback from UE 1 to UE 2 as in 610 of FIG. 6, UEs 1 and 2 capture local ambient sound, 1010 and 1015 (e.g., as in 805A and 810A of FIG. 8A). UEs 1 and 2 report their respective locally captured ambient sound to the authentication server 800 (e.g., via the RAN 120 or some other connection), 1020 and 1025 (e.g., as in 815A and 820A of FIG. 8A). In an example, because UE 1 is already connected to the RAN 120, UE 2 may stream its captured local ambient sound to UE 1 for the reporting of 1025 in an example. The authentication server 800 compares the locally captured local ambient sound reported by UE 1 at 1020 with the locally captured local ambient sound reported by UE 2 at 1025 to determine a degree of environmental similarity for UEs 1 and 2, 1030 (e.g., as in 825A of FIG. 8A), after which the authentication server 800 determines that the determined degree of similarity is not above a threshold, 1035 (e.g., as in 830A of FIG. 8A). For example, the determined degree of similarity is not above the threshold at 1035 because the operator of UE 1 is inside the house 500 with UE 1 and is not actually inside the vehicle, such that the respective environments of UEs 1 and 2 are dissimilar. Thereby, the authentication server 800 does not authenticate UEs 1 and 2 as being in the shared environment, 1040 (e.g., as in 835A of FIG. 8A), the authentication server 800 notifies UE 1 regarding the lack of environmental authentication, 1045, and can also optionally notify UE 2 regarding the lack of environmental authentication at 1045 (e.g., as in 840A of FIG. 8A). The notification for UE 2 is optional at 1045 because UE 1 is in control of whether the call control function is transferred so UE 2 does not necessarily need to know the authentication results. UE 1 determines that the respective environments or UEs 1 and 2 are not authenticated as a shared environment and thereby does not transfer the call control functions to UE 2 based on the lack of environmental authentication, 1050 (e.g., as in 845A or 850A of FIG. 8A)

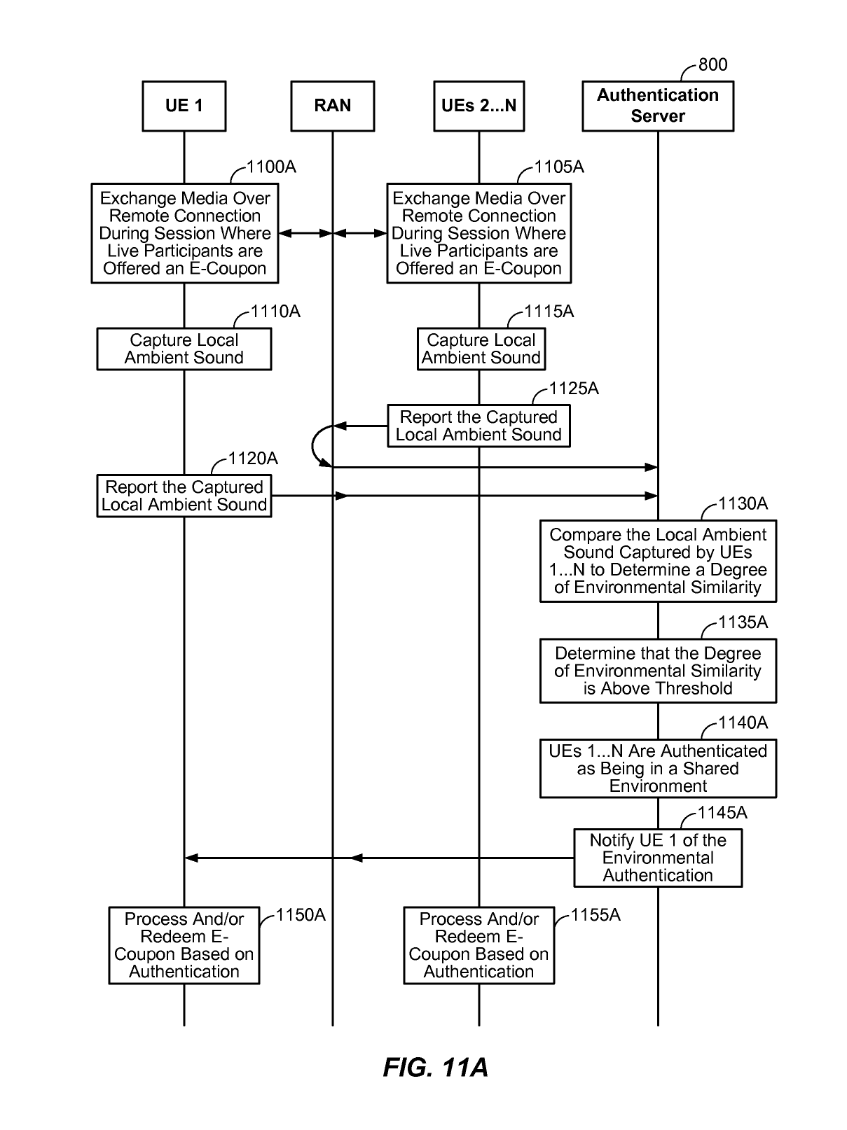

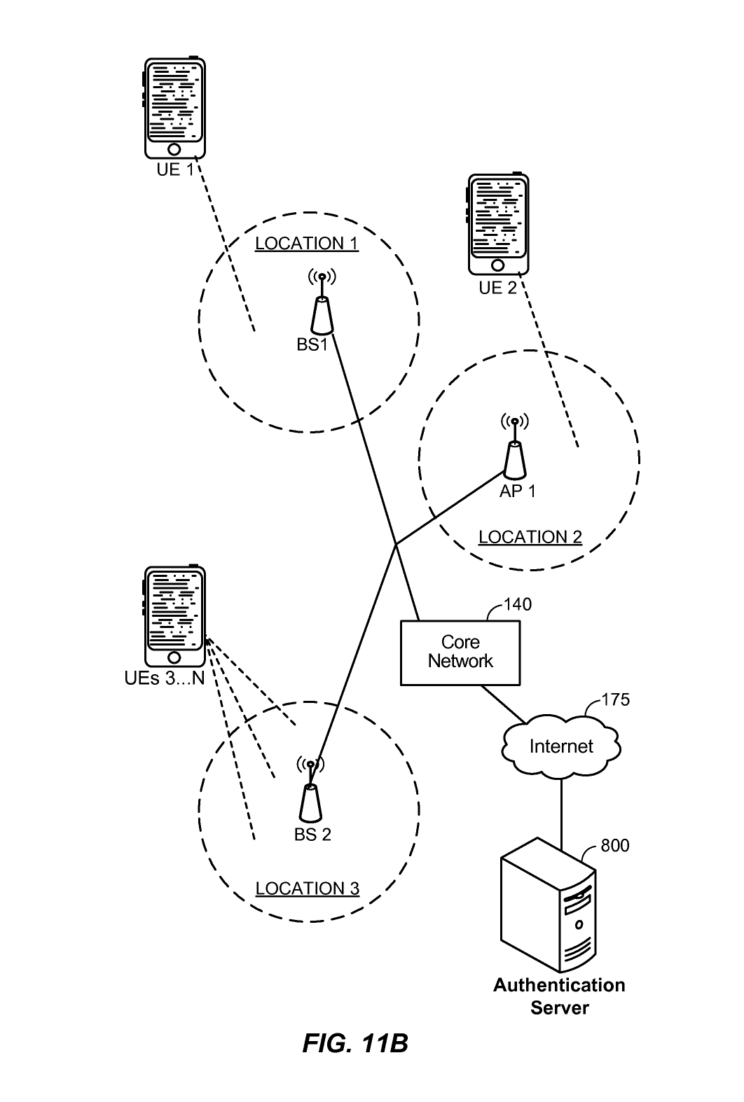

FIG. 11A illustrates an example implementation of FIGS. 8A-8B in accordance with another embodiment of the invention. In FIG. 11A, UEs 1 . . . N are engaged in a live or real-time communication session, and thereby exchange media for the communication session at 1100A and 1105A. In the embodiment of FIG. 11A, assume that live participants in the communication session are offered an E-coupon of some kind, such as a discount at an online retailer. For example, UEs 1 . . . N may be watching the same TV show and the communication session may permit social feedback pertaining to the TV show to be exchanged between UEs 1 . . . N during the viewing session whereby the E-Coupon relates to a product or service advertised during the TV show. In another example, UEs 1 . . . N may be engaged in a group audio conference session whereby the E-Coupon may be offered to lure more attendees to the session. Referring to FIG. 11B, UEs 1 . . . N can be positioned at different locations in a communications system and can be connected to different access networks (e.g., UE 1 is shown as being positioned in a coverage area of base station 1 of the RAN 120, UE 2 is shown as being positioned in a coverage area of WiFi Access Point 1 and UEs 3 . . . N are shown as being positioned in a coverage area of base station 2 of the RAN 120). Thus, two or more of UEs 1 . . . N are remote from each other, but each of UEs 1 . . . N is still part of the same shared environment by virtue of the audio characteristics associated with the real-time communication session.

During the communication session between UEs 1 . . . N, UEs 1 . . . N each independently capture local ambient sound, 1110A and 1115A (e.g., as in 805A and 810A of FIG. 8A). UEs 1 . . . N each report their respective locally captured ambient sound to the authentication server 800 (e.g., via the RAN 120 or some other connection), 1120A and 1125A (e.g., as in 815A and 820A of FIG. 8A). The authentication server 800 compares the locally captured local ambient sound reported by UEs 1 . . . N to determine a degree of environmental similarity for UEs 1 . . . N, 1130A (e.g., as in 825A of FIG. 8A), after which the authentication server 800 determines that the determined degree of similarity is above a threshold, 1135A (e.g., as in 830A of FIG. 8A). For example, the determined degree of similarity may be determined to be above the threshold 1135A because each of UEs 1 . . . N is playing audio associated with the communication session (even though the session will sound slightly different in proximity to each UE based on volume levels, distortion, speaker quality, differences between human speech versus speech output by a speaker, and so on).

Thereby, the authentication server 800 authenticates UEs 1 and 2 as being in the shared environment, 1140A (e.g., as in 800B of FIG. 8B), and the authentication server 800 notifies UEs 1 . . . N regarding the environmental authentication, 1145A (e.g., as in 805B of FIG. 8B). In this case, notification of the authentication at 1145A functions to activate or deliver the E-Coupons to UEs 1 . . . N, such that UEs 1 . . . N each process (and potentially some of the UEs may even redeem) the E-Coupons at 1150A and 1155A (e.g., as in 810B through 815B of FIG. 8B, whereby each UE selects itself as a target UE for performing the given action of processing and/or redeeming the E-coupon).

While not illustrated explicitly in FIG. 11A, it is possible that a subset of UEs 1 . . . N may be part of a shared environment while one or more other UEs are not part of the shared environment. For example, if an operator turns off the volume of his/her UE altogether, that UE will have a dissimilar audio environment as compared to the other UEs that are outputting the audio for the session. Thereby, it is possible that some UEs are authenticated as being in a shared environment while other UEs are not authenticated.

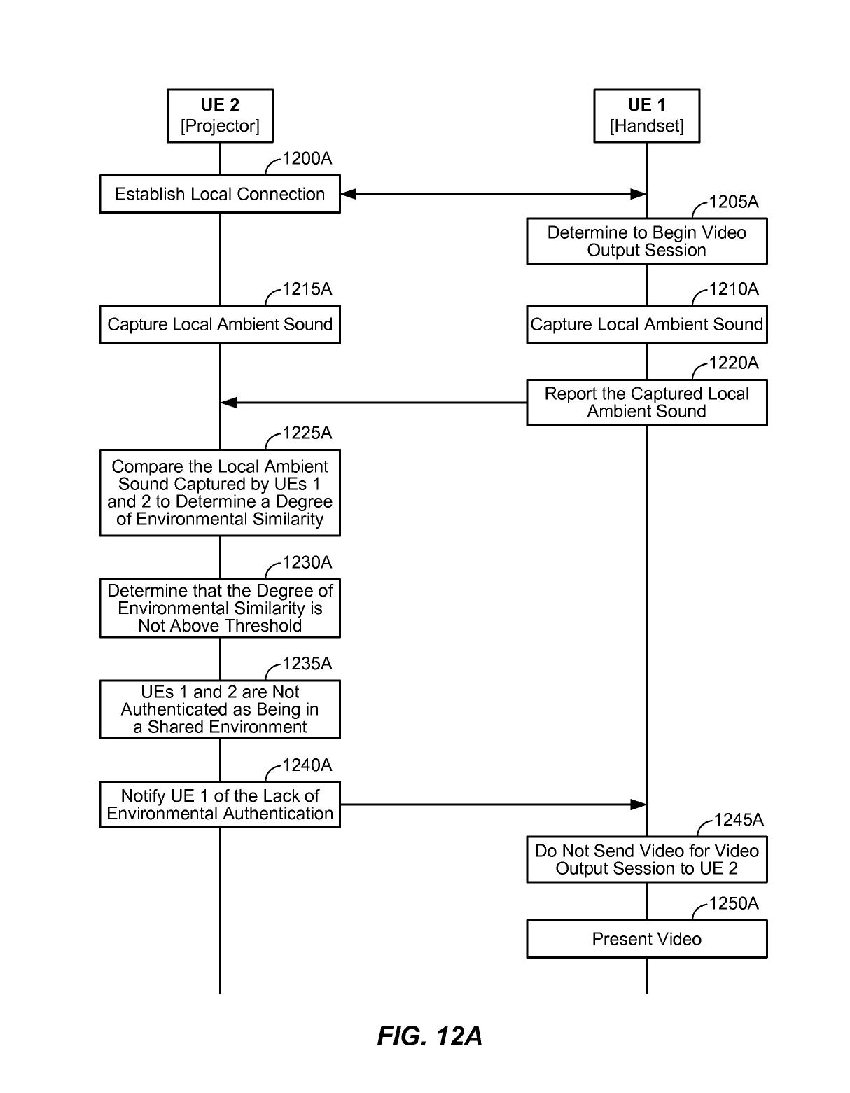

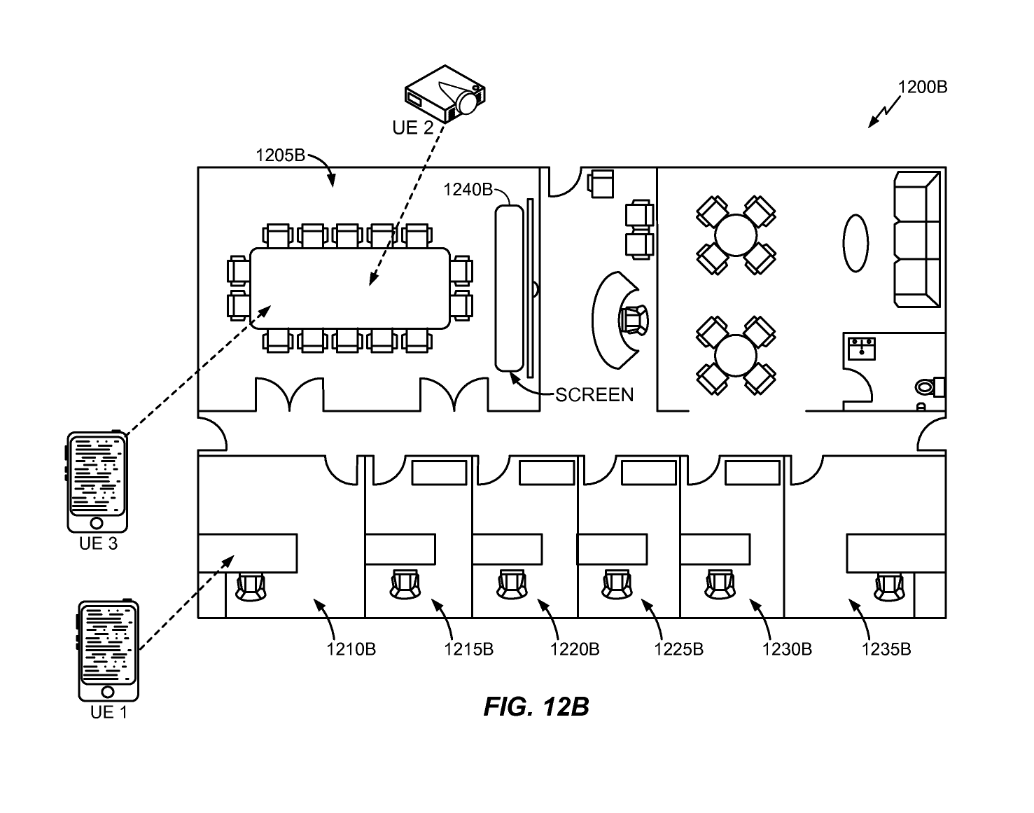

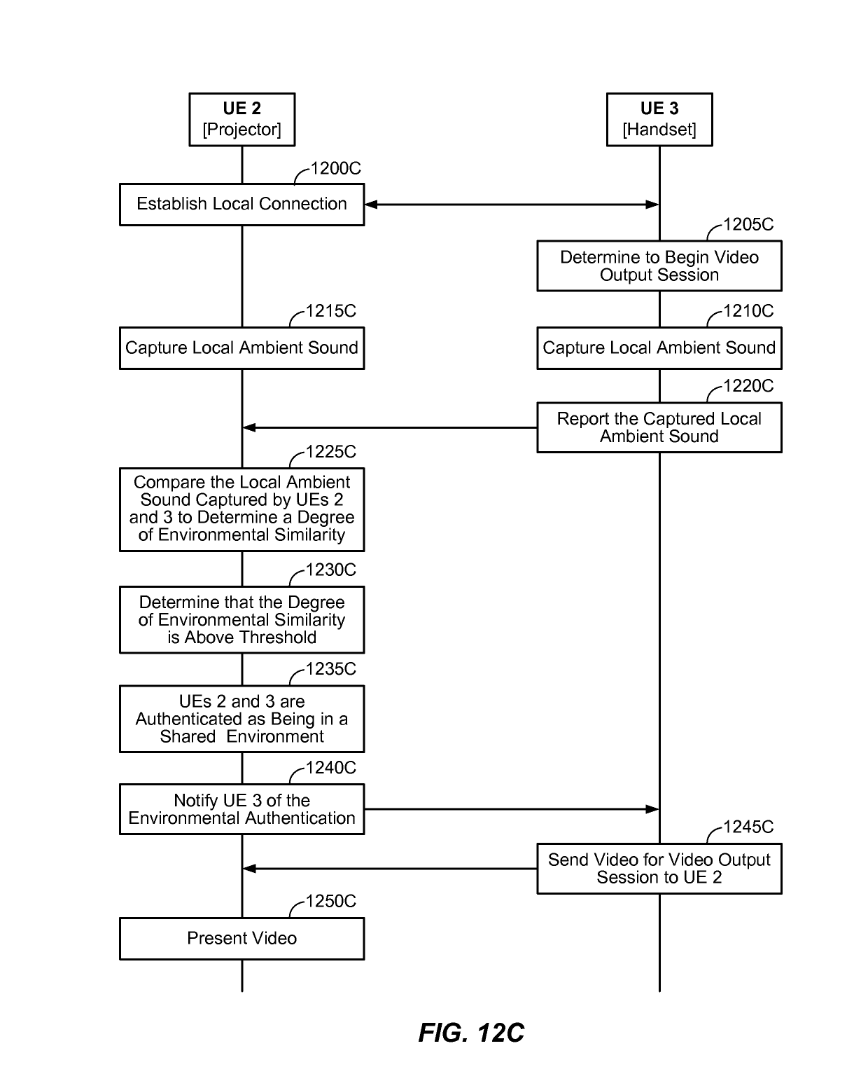

FIG. 12A illustrates an example implementation of FIGS. 9A-9B in accordance with an embodiment of the invention. In particular, the process of FIG. 12A is implemented for a scenario as shown in FIG. 12B. In FIG. 12B, an office space 1200B with a conference room 1205B and a plurality of offices 1210B through 1235B is illustrated. Within the office space 1205B, UE 1 is positioned inside office 1210B, and UEs 2 and 3 are positioned in the conference room 1205B. UEs 1 and 3 are handset devices, while UE 2 is a projector that projects data onto a projection screen 1240B.

In the embodiment of FIG. 12A, under the assumptions discussed above with respect to FIG. 12B, UEs 1 and 2 establish a local connection (e.g., a local P2P wireless connection) such as a Bluetooth connection, 1200A (e.g., as in 900A). While connected to UE 2, UE 1 determines to begin a video output session, 1205A. For example, an operator of UE 1 may request that a YouTube video be played at 1205A, etc. In response to either the connection establishment of 1200A or the determination from 1205A, UEs 1 and 2 each independently capture local ambient sound, 1210A and 1215A (e.g., as in 905A and 910A of FIG. 9A). In the embodiment of FIG. 12A, assume that UE 2 is acting as the authentication device.

UE 1 (e.g., the handset) reports its locally captured ambient sound to UE 2 (e.g., via the connection from 1200A), 1220A (e.g., as in 915A of FIG. 9A). UE 2 (e.g., the projector) compares the locally captured local ambient sound reported by UE 1 with its own locally captured ambient sound from 1215A to determine a degree of environmental similarity for UEs 1 and 2, 1225A (e.g., as in 920A of FIG. 9A), after which UE 2 determines that the determined degree of similarity is not above a threshold, 1230A (e.g., as in 925A of FIG. 9A). For example, the determined degree of similarity may be determined not to be above the threshold 1230A because UEs 1 and 2 are in different rooms of the office space 1200B. Thereby, UE 2 does not authenticate UEs 1 and 2 as being in the shared environment, 1235A (e.g., as in 930A of FIG. 9A), UE 2 notifies UE 1 of the lack of environmental authentication, 1240A (e.g., as in 935A of FIG. 9A), and UE 1 does not send video for the video output session to UE 2 based on the notification, 1245A (e.g., as in 940A and 945A of FIG. 9A). Instead, UE 1 presents the video for the video output session on its local display screen, 1250A. As will be appreciated, in context with FIG. 7A, the set of other UEs relative to UE 1 could include UE 3 in addition to UE 2. However, UE 3 is also not in the shared environment with UE 1, and even if it were, UE 3 lacks the desired presentation capability so UE 3 would not be selected to support the video output session in any case.

FIG. 12C illustrates an example implementation of FIGS. 9A-9B in accordance with another embodiment of the invention. In particular, the process of FIG. 12A is implemented for a scenario as shown in FIG. 12B. While the process of FIG. 12A focuses on interaction between UEs 1 and 2 (i.e., UEs in different rooms of the office space 1200B), the process of FIG. 12C focuses on interaction between UEs 2 and 3 (i.e., UEs that are both in the conference room 1205B).

In the embodiment of FIG. 12C, under the assumptions discussed above with respect to FIG. 12B, UEs 2 and 3 establish a local connection (e.g., a local P2P wireless connection) such as a Bluetooth connection, 1200C (e.g., as in 900A). While connected to UE 2, UE 3 determines to begin a video output session, 1205C. For example, an operator of UE 3 may request that a YouTube video be played at 1205C, etc. In response to either the connection establishment of 1200C or the determination from 1205C, UEs 2 and 3 each independently capture local ambient sound, 1210C and 1215C (e.g., as in 905A and 910A of FIG. 9A). In the embodiment of FIG. 12C, assume that UE 2 is acting as the authentication device.

UE 3 (e.g., the handset) reports its locally captured ambient sound to UE 2 (e.g., via the connection from 1200C), 1220C (e.g., as in 915A of FIG. 9A). UE 2 (e.g., the projector) compares the locally captured local ambient sound reported by UE 3 with its own locally captured ambient sound from 1215C to determine a degree of environmental similarity for UEs 2 and 3, 1225C (e.g., as in 920A of FIG. 9A), after which UE 2 determines that the determined degree of similarity is above a threshold, 1230C (e.g., as in 925A of FIG. 9A). For example, the determined degree of similarity may be determined to be above the threshold 1230C because UEs 2 and 3 are in the same room (i.e., conference room 1205B) of the office space 1200B. Thereby, UE 2 authenticates UEs 2 and 3 as being in the shared environment, 1235C (e.g., as in 900B of FIG. 9B), UE 2 notifies UE 3 of the environmental authentication, 1240C (e.g., as in 905B of FIG. 9B), UE 3 begins to stream video for the video output session to UE 2 (i.e., the projector), 1245C (e.g., as in 915B of FIG. 9B) and UE 2 presents the video for the video output session on the projection screen 1240B, 1250C (e.g., as in 910B of FIG. 9B). As will be appreciated, in context with FIG. 7A, the set of other UEs relative to UE 3 could include another UE in the conference room 1205B. However, even if the other UE is authenticated as being in the conference room 1205B along with UEs 2 and 3, UE 2 may select itself instead of the other UE for handling the presentation component of the video output session based on UE 2 having the desired presentation capability in an example.

Also, while not shown explicitly in FIGS. 12A-12C, it is possible that multiple UEs in the conference room 1205B may try to stream video to the projector at the same time. In this case, the projector (or UE 2) may authenticate the multiple UEs as each being in the shared environment and may then execute decision logic to select one (or more) of the UEs for supporting video via the projector. For example, the projector can execute a split-screen (or picture-in-picture (PIP)) procedure so that video from each of the multiple UEs is presented on a different portion of the projection screen 1240B. In another example, the projector can select a subset of the multiple UEs based on priority and only permit video to be presented on the projection screen 1240B for UEs that belong to that subset. The subset can be selected based on UE priority in an example, or based on which of the multiple UEs have the highest degree of environmental similarity with the project in another example.

Shared secret keys (SSKs) (e.g., passwords, passphrases, etc.) are commonly used for authenticating devices to each other. An SSK is any piece of data that is expected to be known only to a set of authorized parties, so that the SSK can be used for the purpose of authentication. SSKs can be created at the start of a communication session, whereby the SSKs are generated in accordance with a key-agreement protocol (e.g., a public-key cryptographic protocol such as Diffie-Hellman, or a symmetric-key cryptographic protocol such as Kerberos). Alternatively, a more secure type of SSK referred to a pre-shared key (PSK) can be used, whereby the PSK is exchanged over a secure channel before being used for authentication.

Embodiments of the invention that will be described below are more specifically directed to triggering SSK generation based on a degree to which local ambient sound at a set of connected UEs are similar. More specifically, the degree to which the local ambient sound is similar can be used to authenticate whether or not the connected UEs are operating in the same, shared environment, and the environmental authentication can then trigger the SSK generation.

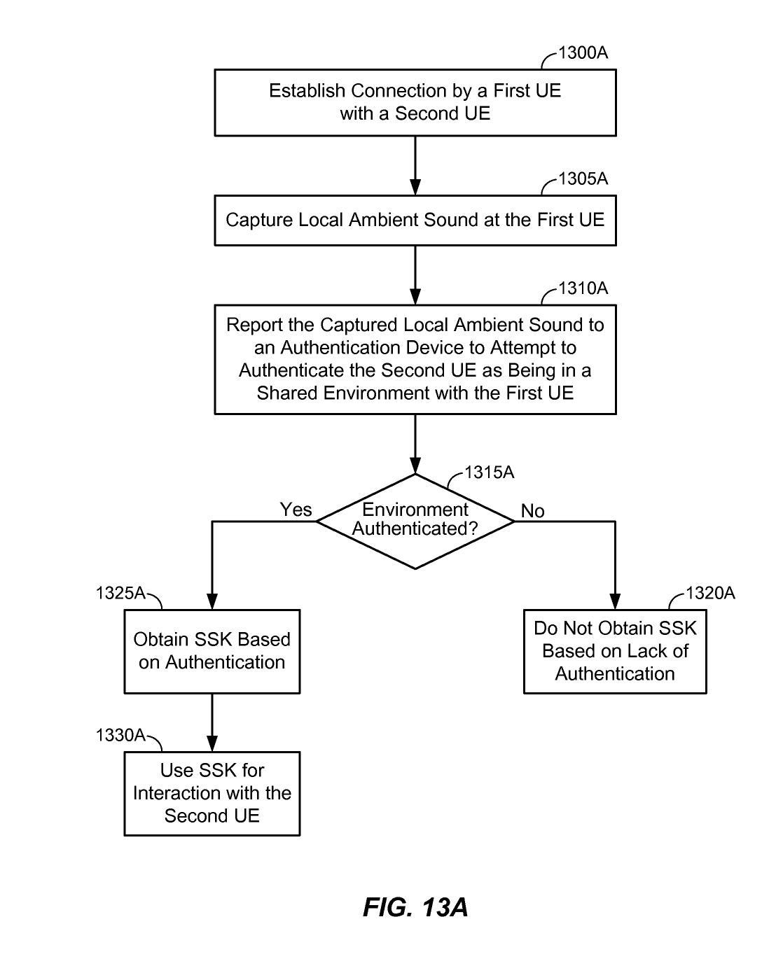

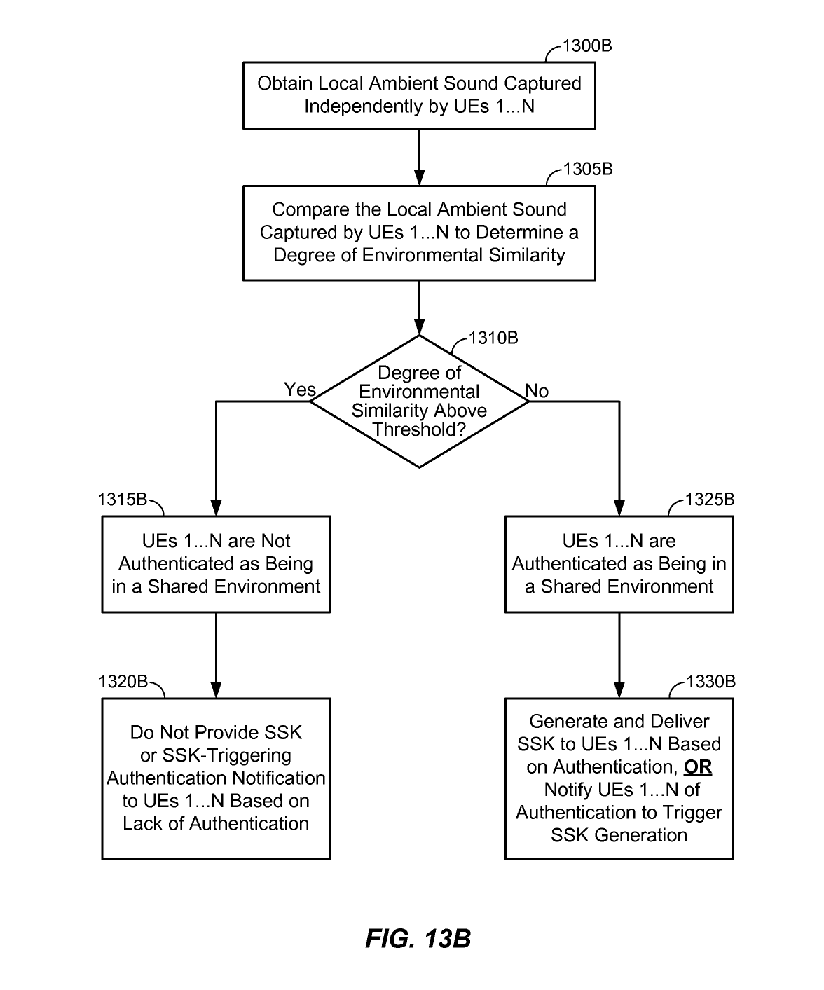

FIG. 13A illustrates a process of selectively executing obtaining an SSK at a first UE based on whether the first UE is authenticated as being in a shared environment with a second UE in accordance with an embodiment of the invention. FIG. 13A can be implemented as a parallel process to FIG. 7A in an example, such that SSKs can either be obtained or not obtained based on the same environmental authentication that occurs in FIG. 7A with respect to selection of the target device for performing the given action. Below, FIGS. 13A-16B are primarily described two respect to a set of two UEs, but it will be appreciated that the SSK generation procedure can be extended to three or more UEs so long as each of the three or more UEs are authenticated as being in the same shared environment.

Referring to FIG. 13A, 1300A through 1315A substantially correspond to 700A through 715A of FIG. 7A, respectively, and will thereby not be described further for the sake of brevity. If the first UE determines that the first and second UEs are not authenticated as being within the shared environment at 1315A, the first UE does not obtain an SSK that is shared with the second UE, 1320A. Alternatively, if the first UE determines that the first and second UEs are authenticated as being within the shared environment at 1315A, the first UE obtains an SSK that is shared with the second UE based on the authentication, 1325A. The SSK can be obtained at 1325A in a number of different ways.

In an example of 1325A of FIG. 13A, the authentication device can indicate to the first UE that the first and second UEs are authenticated as being in the shared environment, which can trigger independent SSK generation at the first UE based on the locally captured ambient sound reported at 1310A. In this case, the second UE will be expected to generate the same SSK independently as well based on its reported local ambient sound (not shown in FIG. 13A), so that the similar sound environments at the first and second UEs are used to produce the respective SSKs at the first and second UEs. As will be appreciated, the locally captured ambient sounds for environmentally authenticated UEs, while similar, are unlikely to be identical. For this reason, it can be difficult to produce identical SSKs when the SSKs are generated independently (as opposed to being generated at a central source and then shared). To account for this scenario, in a first example, a similarity-based SSK generation algorithm can be used so that identical SSKs can be generated using non-identical information. For instance, assume that UEs 1 and 2 are in similar environments because UEs 1 and 2 are in the same room. In this case, a less precise audio signature of the locally captured sound at UEs 1 and 2 can be generated using a sound-blurring algorithm, whereby the less precise audio signatures are identical even though discrepancies existed in the more precise raw versions of the audio captured by UEs 1 and 2. Alternatively, in a second example, fault-tolerant independent SSK generation can be implemented whereby a certain degree of SSK differentiation is acceptable. In this case, identical SSKs are not strictly necessary for subsequent authentication, and instead a degree to which two SSKs are similar to each other can be gauged to identify whether to authenticate a device. Accordingly, some sound variance between environmentally authenticated UEs can be accounted for either by taking the variance into account in a manner that will still produce identical SSKs, or alternatively permitting the variance to produce non-identical SSKs and then using an SSK-similarity algorithm to authenticate SSKs that are somewhat different from each other.

In another example of 1325A of FIG. 13A, the authentication device can be responsible for generating and disseminating an SSK to the first and second UEs in conjunction with notifying the first and second UEs regarding their authentication of operating in the shared environment. In another example of 1325A of FIG. 13A, if the authentication device is the first UE or the second UE, the authentication device generates the SSK and then streams it to the other UE over the connection from 1300A.

Accordingly, there are many different ways that SSKs can be obtained at the first UE (and also the second UE) based upon the shared environment authentication. Regarding the SSK itself, the SSK can correspond to any type of SSK in an example. In a further example, the SSK can correspond to a hash of the locally captured ambient sound (or the information extracted or gleaned from the locally captured ambient sound, such as the above-noted audio signature, media program identification, watermark, etc.) at either the first UE or the second UE. As will be appreciated, the locally captured ambient sound at the first and second UEs needs to be somewhat similar for the authentication device to conclude that the first and second UEs are operating in the shared environment, and any similar aspects of the locally captured ambient sound at the first and second UEs can be hashed to produce the SSK in an example. The hashing can be implemented at the first UE, the second UE and/or the authentication device in different implementation, because each of these devices has access to a version of the ambient sound captured by at least one of the first and second UEs in the embodiment of FIG. 13A.

After obtaining the SSK at 1325A, the first UE uses the SSK for interaction with the second UE, 1330A. As will be explained below in more detail, the SSK can be used in a variety of ways. For example, the SSK obtained at 1325A can be used to encrypt or decrypt communications exchanged between the first and second UEs over the connection established at 1300A or a subsequent connection. In another example, the SSK obtained at 1325A can be used to verify the authenticity of the first UE to the second UE (or vice versa) during set-up of a subsequent connection, and/or to encrypt or decrypt communications exchanged between the first and second UEs over the subsequent connection (in which case the SSK is a PSK).

While FIG. 13A is described with respect to two UEs, it will be appreciated that FIG. 13A can also be applied to three or more UEs, whereby the connection established at 1300A is between a larger group of UEs and the first UE is trying to authenticate whether it is in a shared environment with any (or all) of the other UEs in the group.

FIG. 13B illustrates a process of authenticating whether two (or more) UEs are in a shared environment in accordance with an embodiment of the invention. Referring to FIG. 13B, 1300B through 1315B and 1325B substantially correspond to 700B through 715B and 725B of FIG. 7B, respectively, and as such will not be described further for the sake of brevity.

Referring to FIG. 13B, if the authentication device determines that the degree of environmental similarity is not above the threshold at 1310B, the authentication device neither provides an SSK to UEs 1 . . . N nor delivers a notification that would trigger UEs 1 . . . N to self-generate their own SSK, 1320B. In other words, the authentication device takes no action that would facilitate SSK generation at 1320B because UEs 1 . . . N are deemed not to be operating within the shared environment. Thereby, 1320B of FIG. 13B corresponds to a modified implementation of optional 720B of FIG. 7B.

Otherwise, if the authentication device determines that the degree of environmental similarity is above the threshold at 1310B, the authentication device either (i) generates an SSK and delivers the SSK to UEs 1 . . . N based on the environmental authentication, or (ii) notifies UEs 1 . . . N of the environmental authentication to trigger SSK generation at one of more of UEs 1 . . . N, 1330B. Example implementations of FIGS. 13A-13B will be described below to provide more explanation of these embodiments.

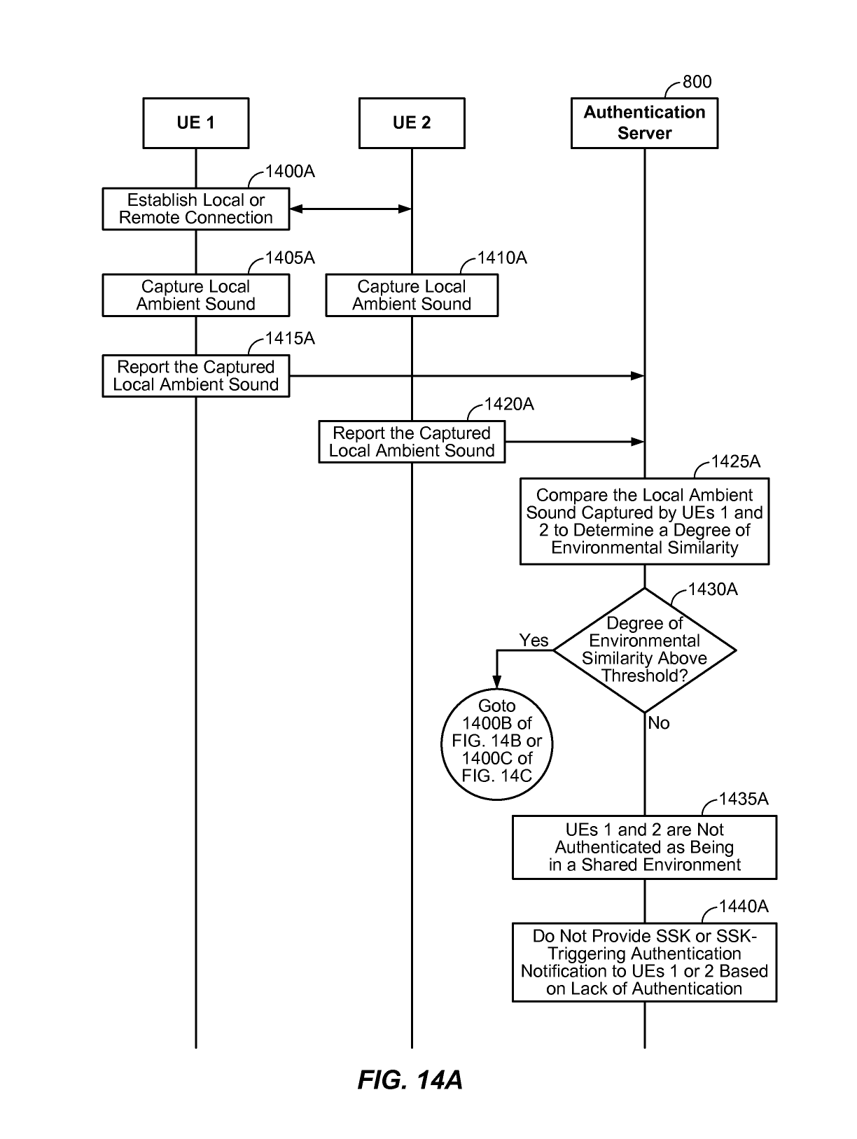

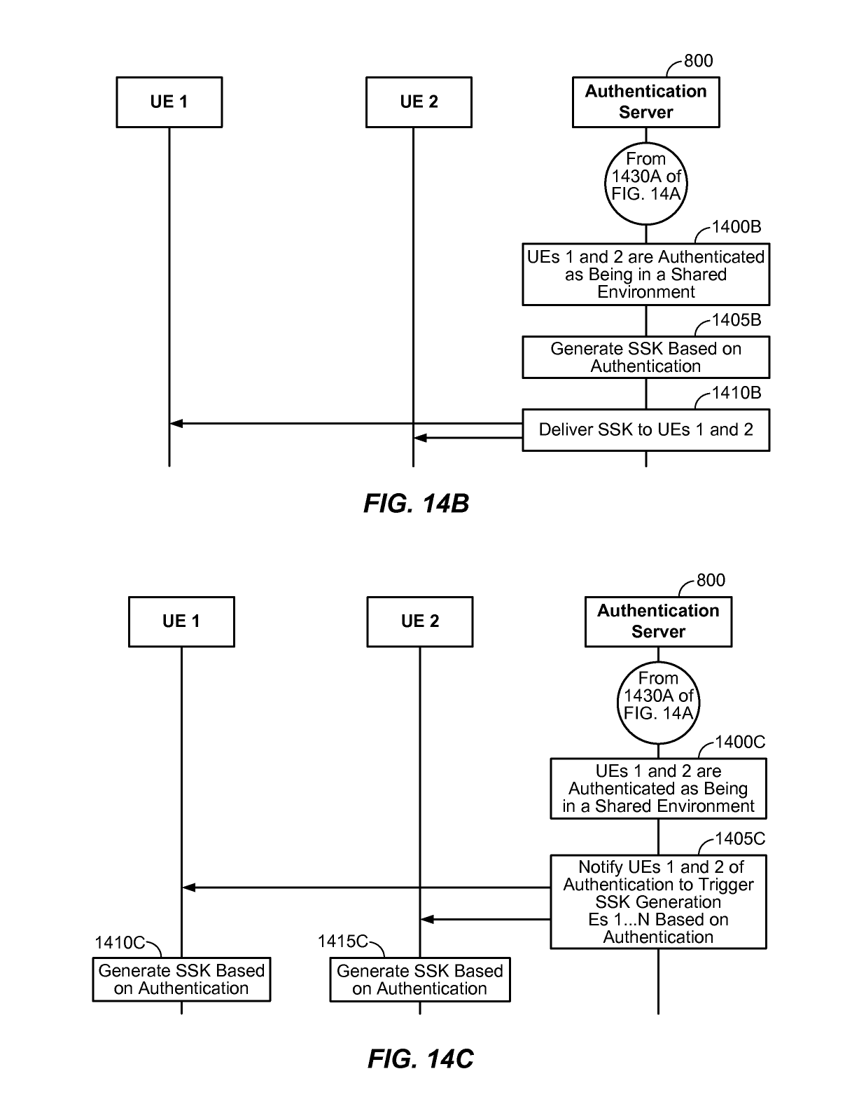

FIGS. 14A-14C illustrate example implementations of the processes of FIGS. 13A-13B whereby the authentication device corresponds to the authentication server 800. Referring to FIG. 14A, 1400A through 1435A substantially correspond to 800A through 835A of FIG. 8A, respectively. If the determined degree of similarity is determined not to be above the threshold at 1430A, the authentication server 800 neither provides an SSK to UEs 1 and/or 2 nor delivers a notification that would trigger UEs 1 and/or 2 to self-generate their own SSK, 1440A (e.g., as in 1320B of FIG. 13B). Returning to 1430A, if the determined degree of similarity is determined to be above the threshold, the process advances either to 1400B or FIG. 14B or 1400C of FIG. 14C, which illustrate alternative continuations from 1430A of FIG. 14A.

Referring to FIG. 14B, after the determined degree of similarity is determined to be above the threshold at 1430A, the authentication server 800 authenticates UEs 1 and 2 as being in the shared environment, 1400B (e.g., as in 1325B of FIG. 13B), the authentication server 800 generates an SSK based on the environmental authentication (e.g., using a hash of the reported ambient sound from UEs 1 and 2, etc.) from 1400B, 1405B (e.g., as in option (i) from 1330B of FIG. 13B) and delivers the SSK to UEs 1 and 2 based on the environmental authentication, 1410B (e.g., as in option (i) from 1330B of FIG. 13B).

Referring to FIG. 14C, after the determined degree of similarity is determined to be above the threshold at 1430A, the authentication server 800 authenticates UEs 1 and 2 as being in the shared environment, 1400C (e.g., as in 1325B of FIG. 13B), the authentication server 800 notifies UEs 1 and 2 of the environmental authentication to trigger SSK generation at UEs 1 and 2, 1405C (e.g., as in 1330B of FIG. 13B). UEs 1 and 2 receive the notification from 1405C and each independently generate an SSK based on the environmental authentication (e.g., using a hash of the ambient sound captured at UEs 1 and/or 2, etc.), 1410C and 1415C (e.g., as in option (ii) from 1330B of FIG. 13B). As discussed above, the SSKs can be independently generated at 1410C and 1415C in a manner that will account for some sound variance between the local captured sounds at UEs 1 and 2 either by taking the variance into account in a manner that will still produce identical SSKs, or alternatively permitting the variance to produce non-identical SSKs and then using an SSK-similarity algorithm to authenticate SSKs that are somewhat different from each other. Alternatively, while not shown in FIG. 14C explicitly, the authentication server 800 may deliver the notification of 1405C to one of UEs 1 and 2, and that UE may generate the SSK and then deliver the SSK to the other UE, such that the SSK need not be independently generated at each UE sharing the SSK.

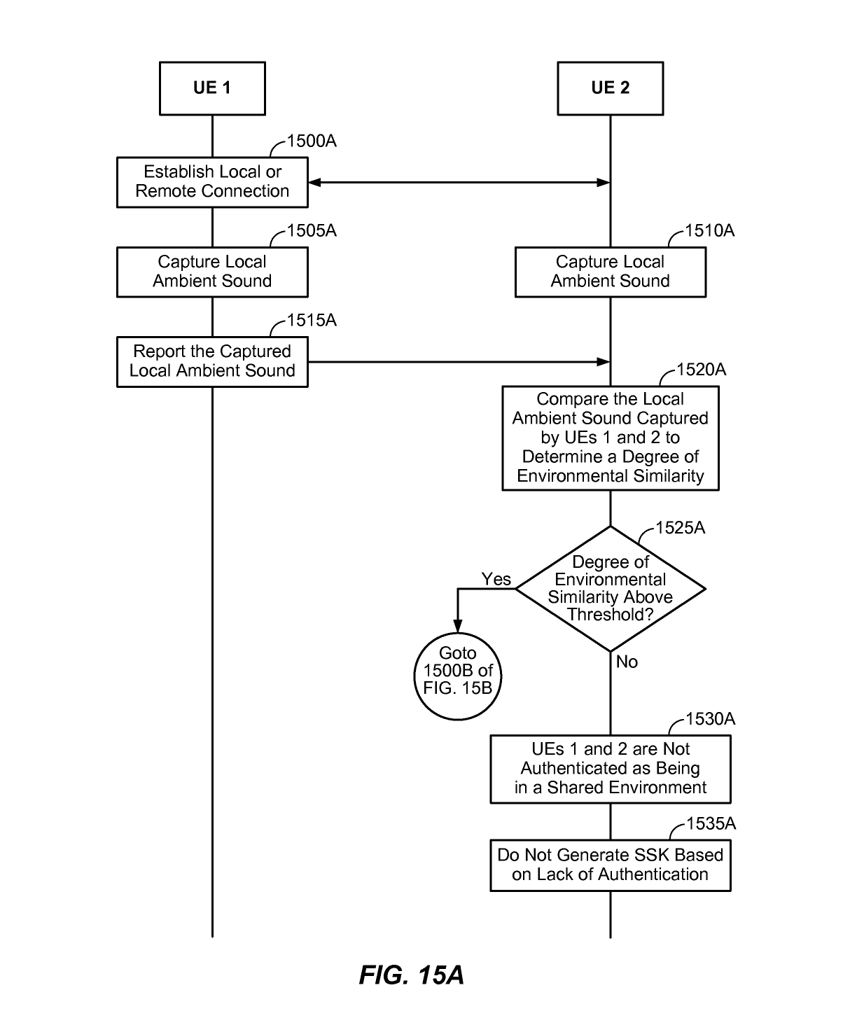

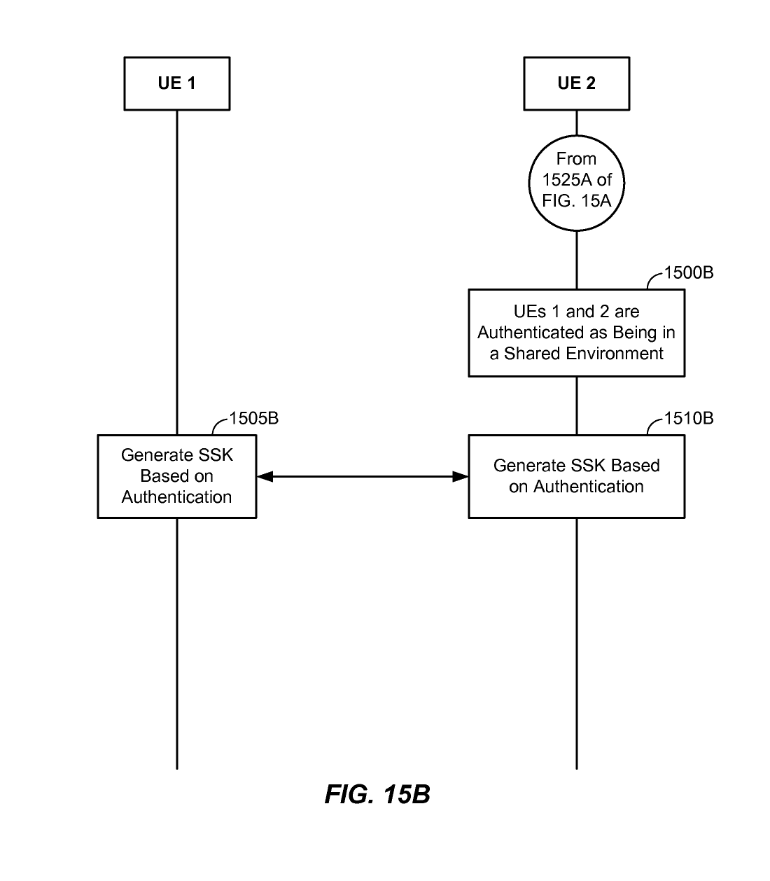

FIGS. 15A-15B illustrate another example implementation of the processes of FIGS. 13A-13B whereby the authentication device corresponds to one of the UEs (“UE 2”) instead of the authentication server 800 as in FIGS. 14A-14C. Referring to FIG. 15A, 1500A through 1530A substantially correspond to 900A through 930A of FIG. 9A, respectively. If the determined degree of similarity is determined not to be above the threshold at 1525A, UE 2 does not generate (and/or trigger UE 1 to generate) an SSK to be shared with UE 1, 1535A (e.g., as in 1320B of FIG. 13B). Returning to 1525A, if the determined degree of similarity is determined to be above the threshold, the process advances to FIG. 15B whereby UE 2 authenticates UEs 1 and 2 as being in the shared environment, 1500B (e.g., as in 1325B of FIG. 13B), after which UEs 1 and 2 generate an SSK based on the environmental authentication, 1505B and 1510B. The SSK generated at 1505B and 1510B can be independently generated at UEs 1 and 2 (e.g., UE 2 generates an SSK and separately notifies UE 1 of the environmental authentication to trigger UE 1 to self-generate the SSK on its own) or the SSK can be generated at UE 1 or UE 2 and then shared with the other UE over the connection established at 1500A of FIG. 15A. As discussed above, in the case of independent SSK generation, the SSKs can be independently generated at 1505B and 1510B in a manner that will account for some sound variance between the local captured sounds at UEs 1 and 2 either by taking the variance into account in a manner that will still produce identical SSKs, or alternatively permitting the variance to produce non-identical SSKs and then using an SSK-similarity algorithm to authenticate SSKs that are somewhat different from each other.

A variety of implementation examples of SSK generation in accordance with the above-noted embodiments will now be provided with respect to certain Figures that have already been introduced and discussed with respect to authentication environments in a more general manner, in particular, FIGS. 5A-5B, 11B and 12B.

For example, in context with the processes of any of FIGS. 13A through 15B, UEs 1 and 2 would be determined to be operating within a shared environment in the scenario shown in FIG. 5A, while UEs 1 and 2 would not be determined to be operating within a shared environment in the scenario shown in FIG. 5B. Thus, during execution of one or more of FIGS. 13A through 15B, an SSK would be obtained by UEs 1 and 2 for the scenario shown in FIG. 5A and not for the scenario shown in FIG. 5B.

In another example, with respect to FIG. 11B, assume that UEs 1 . . . N are live participants in a communication session. For example, UEs 1 . . . N may be watching the same TV show and the communication session may permit social feedback pertaining to the TV show to be exchanged between UEs 1 . . . N during the viewing session, or UEs 1 . . . N may be engaged in a group audio conference session. In any case, the respective ambient sounds captured at UEs 1 . . . N are sufficiently similar to be authenticated as a shared environment in accordance with any of the processes of FIGS. 13A through 15B as discussed above. Thus, UEs 1 . . . N are remote from each other, but each of UEs 1 . . . N is still part of the same shared environment by virtue of the audio characteristics associated with the real-time communication session. Thereby, during execution of one or more of FIGS. 13A through 15B, an SSK would be obtained by UEs 1 . . . N for the scenario shown in FIG. 11B under the above-noted assumptions.

In another example, in context with the processes of any of FIGS. 13A through 15B, UEs 2 and 3 would be determined to be operating within a shared environment in the scenario shown in FIG. 12B (e.g., because UEs 2 and 3 are in the same room), while UEs 1 and 2 or UEs 1 and 3 would not be determined to be operating within a shared environment in the scenario shown in FIG. 12B (e.g., because UE 1 is in a different room than either UE 2 or UE 3). Thus, during execution of one or more of FIGS. 13A through 15B, an SSK would be obtained by UEs 2 and 3 and would not be obtained by UE 1 for the scenario shown in FIG. 12B.

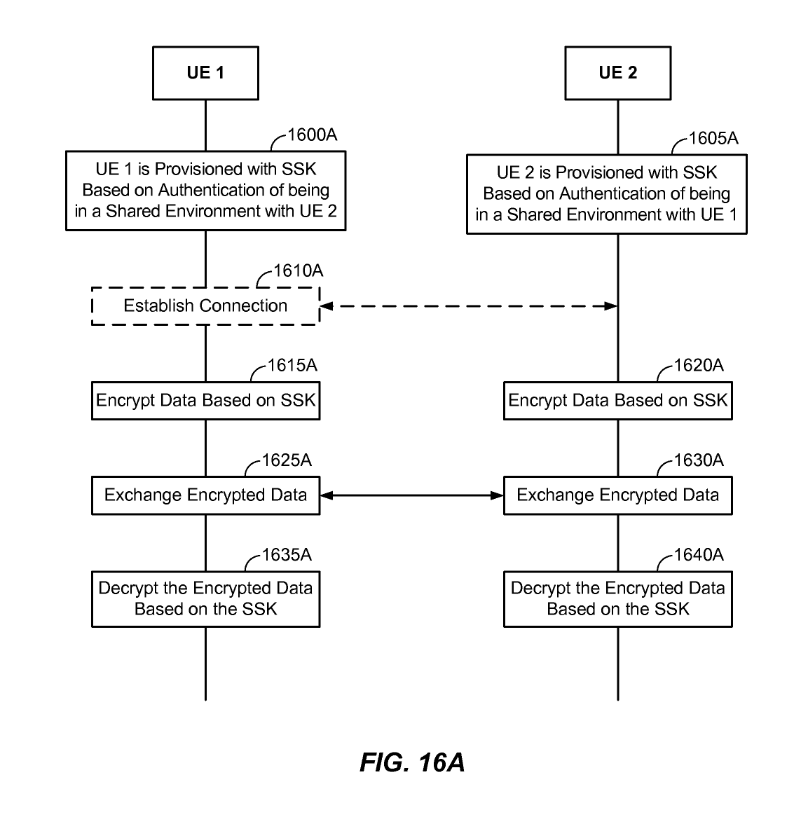

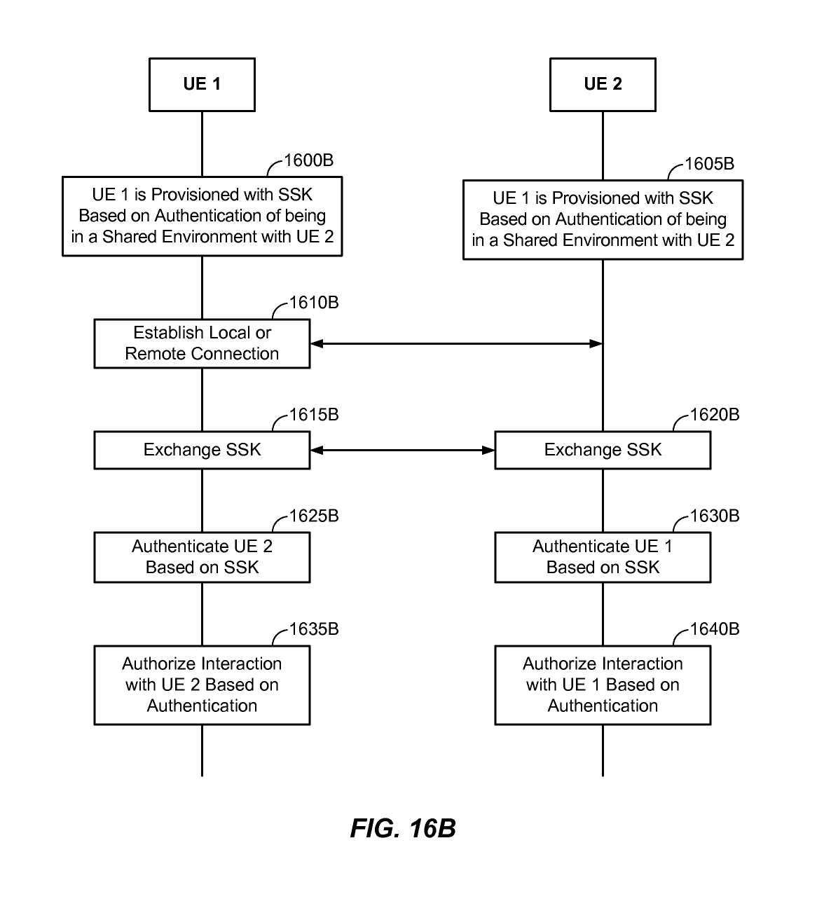

While FIGS. 13A through 15B focus primarily on processes related to obtaining SSKs for UEs authenticated as operating in shared environments, FIGS. 16A and 16B are directed to actions that can be performed by UEs after obtaining the SSKs. In particular, FIG. 16A illustrates an example whereby the SSK is used for encrypting and decrypting data exchanged between UEs 1 and 2 for a current or subsequent connection, whereas FIG. 16B illustrates an example whereby the SSK is a PSK that is used for UE authentication for a subsequent connection.

Referring to FIG. 16A, UEs 1 and 2 are each provisioned with an SSK based on an earlier authentication of being in a shared environment with each other, 1600A and 1605A. For example, the SSK provisioning of 1600A and/or 1605A can occur as a result of 1325A of FIG. 13A, 1330B of FIG. 13B, 1410B of FIG. 14B, 1410C or 1415C of FIG. 14C and/or 1505B of 1510B of FIG. 15B. In the embodiment of FIG. 16A, the SSK can be used either in a current connection or a connection session relative to the connection that was active when the SSK was provisioned at UEs 1 and 2. Thus, if the SSK is used during a subsequent connection, the SSK is a PSK and the subsequent connection can be established at 1610A. However, if the SSK is used over the current connection, the operation of 1610A can be skipped because the earlier-established (and current) connection (e.g., from 1300A of FIG. 13A, 1400A of FIG. 14A and/or 1500A of FIG. 15A) is still active.

While UEs 1 and 2 are connected and provisioned with the SSK, UE 1 encrypts data to be transmitted to UE 2 over the connection using the SSK, 1615A, and UE 2 likewise encrypts data to be transmitted to UE 1 over the connection using the SSK, 1620A. UEs 1 and 2 then exchange the encrypted data over the connection, 1625A and 1630A. UE 1 decrypts any encrypted data from UE 2 using the SSK, 1635A, and UE 2 likewise decrypts any encrypted data from UE 1 using the SSK, 1640A.

Referring to FIG. 16B, UEs 1 and 2 are each provisioned with an SSK based on an earlier authentication of being in a shared environment with each other, 1600B and 1605B. For example, the SSK provisioning of 1600B and/or 1605B can occur as a result of 1325A of FIG. 13A, 1330B of FIG. 13B, 1410B of FIG. 14B, 1410C or 1415C of FIG. 14C and/or 1505B of 1510B of FIG. 15B. In the embodiment of FIG. 16B, assume that the connection that triggered the SSK generation has lapsed, such that the SSK is used as a PSK. With this in mind, UEs 1 and 2 re-establish a connection at 1610B (e.g., which may be the same type of connection or a different type of connection as compared to the connection through which the SSK was established).

In conjunction with setting up the connection at 1610B, UEs 1 and 2 exchange their respective copies of the SSK, 1615B and 1620B. UEs 1 and 2 each compare their own copy of the SSK with the copy of the SSK received from the other UE, which results in UE 1 authenticating UE 2 based on SSK parity, 1625B, and UE 2 likewise authenticating UE 1 based on SSK parity, 1630B. At this point, UE 1 authorizes interaction with UE 2 over the connection based on the authentication from 1625B, 1635B, and UE 2 authorizes interaction with UE 1 over the connection based on the authentication from 1630B, 1640B. In an example, the SSK authentication can be used to authorize whether any interaction is permitted between UEs 1 and 2, or alternatively can be used to authorize a particular degree of interaction between UEs 1 and 2 (e.g., permit non-sensitive files to be exchanged between UE 1 and 2 while blocking sensitive files if there is no SSK authentication, etc.).

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of operating a first user equipment (UE), comprising:
establishing a set of local peer-to-peer (P2P) wireless connections with a set of other UEs, the set of other UEs included among multiple candidate UEs that are candidates for performing a given action with the first UE;
capturing local ambient sound at the first UE while connected to the set of other UEs via the set of local P2P wireless connections;
reporting information associated with the local ambient sound captured at the first UE to an authentication device configured to authenticate whether or not the first UE is in a shared environment with any of the set of other UEs; and
selecting a target UE from the multiple candidate UEs for performing the given action based on whether the authentication device authenticates the first UE and any of the set of other UEs as being in the shared environment.

2. The method of claim 1, wherein the set of other UEs includes a single UE.

3. The method of claim 1, wherein the set of other UEs includes multiple UEs.

4. The method of claim 1, wherein the multiple candidate UEs include the first UE and the set of other UEs.

5. The method of claim 1, wherein the local ambient sound is captured by capturing local audio signals without searching for a particular beacon within the local audio signals.

6. The method of claim 1, wherein the set of local P2P wireless connections includes at least one Bluetooth connection.

7. The method of claim 1, wherein the establishing establishes a remote connection with at least one additional UE.

8. The method of claim 7, wherein the remote connection corresponds to a cellular and/or Internet connection.

9. The method of claim 1, wherein the authentication device corresponds to a server that is remote from the first UE and the set of other UEs.

10. The method of claim 1,
wherein the authentication device corresponds to a second UE among the set of other UEs, and
wherein the reporting sends the reported information to the second UE over a given local P2P wireless connection from the set of local P2P wireless connections.

11. The method of claim 1,
wherein the authentication device corresponds to the first UE, and
wherein the reporting corresponds to internal operation of the first UE.

12. The method of claim 1, further comprising:
receiving a notification from the authentication device that indicates that the first UE and the set of other UEs are not in the shared environment,
wherein the selecting selects the first UE as the target UE based on the notification.

13. The method of claim 1, further comprising:
receiving a notification from the authentication device that indicates that the first UE and at least one UE from the set of other UEs are in the shared environment,
wherein the selecting selects the at least one UE as the target UE based on the notification.

14. The method of claim 1, wherein the at least one UE includes multiple UEs.

15. The method of claim 14,
wherein the selecting selects a single target UE from the multiple UEs as the target UE based on a target UE selection policy, or
wherein the selecting selects two or more target UEs from the multiple UEs based on the target UE selection policy with each of the selected two or more target UEs being selected to perform some portion of the given action.

16. The method of claim 1, wherein the given action corresponds to one or more of:
capturing audio and streaming the captured audio to a communications network on behalf of the first UE, or
capturing audio at the target UE and streaming the captured audio to the first UE for transmission to the communications network, or
receiving audio from the first UE to be played locally and playing the received audio, or
transmitting audio to the first UE to be played locally by the first UE.

17. The method of claim 1, wherein the given action corresponds to one or more of:
receiving video from the first UE and presenting the received video, or
transmitting video to the first UE to be presented locally by the first UE.

18. The method of claim 1, wherein the reported information includes raw audio from the local ambient sound captured at the first UE.

19. The method of claim 1, wherein the reported information includes information that characterizes content from the local ambient sound captured at the first UE.

20. The method of claim 19, wherein the content characterizing information includes a speech-to-text conversion of speech from the local ambient sound captured at the first UE, a user identification of a speech-source from the local ambient sound captured at the first UE, a fingerprint or spectral classification for the local ambient sound captured at the first UE, and/or a media program identification of a media program detected in the local ambient sound captured at the first UE.

21. The method of claim 1, wherein the given action is processing and/or redeeming an E-coupon that is received based on the first UE and at least one UE from the set of other UEs being authenticated as being in the shared environment.

22. The method of claim 1, further comprising:
selectively obtaining a shared secret key (SSK) that is shared between the first and set of other UEs based on whether the authentication device authenticates the first and the set of other UEs as being in the shared environment.

23. The method of claim 22, wherein the selectively obtaining does not obtain the SSK if the first and the set of other UEs are not in the shared environment.

24. The method of claim 22, further comprising:
receiving a notification from the authentication device that indicates that the first and at least one of the set of other UEs are in the shared environment,
wherein the selectively obtaining generates the SSK in response to the notification.

25. The method of claim 22, further comprising:
using the SSK in conjunction with interaction with a second UE among the set of other UEs.

26. The method of claim 25, wherein the using includes:
encrypting data for transmission to the second UE based on the SSK; and
transmitting the encrypted data to the second UE.

27. The method of claim 25, wherein the using includes:
receiving encrypted data from the second UE; and
decrypting the encrypted data based on the SSK.

28. The method of claim 25, wherein the using includes:
establishing another connection with the second UE;
exchanging the SSK with the second UE to authenticate the first UE for the another connection.

29. A method of operating an authentication device, comprising:
obtaining first information associated with local ambient sound captured by a first user equipment (UE);
obtaining second information associated with local ambient sound captured by a second UE while the second UE is connected to the first UE via a local peer-to-peer (P2P) wireless connection;
comparing the first and second information to determine a degree of environmental similarity for the first and second UEs; and
selectively authenticating the first and second UEs as being in a shared environment based on the determined degree of environmental similarity.

30. The method of claim 29, wherein the authentication device corresponds to a server that is remote from the first and second UEs.

31. The method of claim 29, wherein the authentication device corresponds to the first UE or the second UE.

32. The method of claim 29, further comprising:
transmitting a notification to the first UE and/or the second UE that indicates whether or not the first and second UEs are authenticated as being in the shared environment.

33. The method of claim 29, wherein the first information and/or the second information includes raw audio from the local ambient sound captured by the first UE and/or the second UE, respectively.

34. The method of claim 29, wherein the first information and/or the second information characterizes content from the local ambient sound captured by the first UE and/or the second UE, respectively.

35. The method of claim 34, wherein the content characterizing information includes a speech-to-text conversion of speech from the local ambient sound captured by the first UE and/or the second UE, a user identification of a speech-source from the local ambient sound captured by the first UE and/or the second UE, a fingerprint or spectral classification for the local ambient sound captured by the first UE and/or the second UE, and/or a media program identification of a media program detected in the local ambient sound captured by the first UE and/or the second UE.

36. The method of claim 29, further comprising:
obtaining additional information associated with local ambient sound captured by at least one additional UE;
comparing the additional information to determine an additional degree of environmental similarity between the at least one additional UE and the first and/or second UEs; and
selectively authenticating the at least one additional UE and the first and/or second UEs as being in the shared environment based on the determined additional degree of environmental similarity.

37. The method of claim 29, further comprising:
triggering generation of a shared secret key (SSK) for the first and second UEs based on whether the first and second UEs are authenticated as being within the shared environment.

38. The method of claim 37,
wherein the authentication device corresponds to a server that is remote from the first and second UEs,
wherein the first and second UEs are authenticated as being within the shared environment, and
wherein the triggering includes:
generating the SSK at the authentication device; and
delivering the SSK to the first and second UEs.

39. The method of claim 29,
wherein the authentication device corresponds to the first UE,
wherein the triggering includes:
generating the SSK at the first UE; and
delivering the SSK to the second UE.

40. The method of claim 29, wherein the triggering includes:
generating the SSK at the first UE; and
triggering independent generation of the SSK at the second UE.

41. The method of claim 29, wherein the SSK is a hash of (i) the local ambient sound captured at the first and/or second UEs, or (ii) the first and/or second information.

42. The method of claim 29, further comprising:
delivering an E-coupon to the first and/or second UEs in response to the first and second UEs being authenticated as being in the shared environment.

43. A user equipment (UE), comprising:
means for establishing a set of local peer-to-peer (P2P) wireless connections with a set of other UEs, the set of other UEs included among multiple candidate UEs that are candidates for performing a given action with the UE;
means for capturing local ambient sound at the UE while connected to the set of other UEs via the set of local P2P wireless connections;
means for reporting information associated with the local ambient sound captured at the UE to an authentication device configured to authenticate whether or not the UE is in a shared environment with any of the set of other UEs; and
means for selecting a target UE from the multiple candidate UEs for performing the given action based on whether the authentication device authenticates the UE and any of the set of other UEs as being in the shared environment.

44. An authentication device, comprising:
means for obtaining first information associated with local ambient sound captured by a first user equipment (UE);
means for obtaining second information associated with local ambient sound captured by a second UE while the second UE is connected to the first UE via a local peer-to-peer (P2P) wireless connection;
means for comparing the first and second information to determine a degree of environmental similarity for the first and second UEs; and
means for selectively authenticating the first and second UEs as being in a shared environment based on the determined degree of environmental similarity.

45. A user equipment (UE), comprising:
logic configured to establish a set of local peer-to-peer (P2P) wireless connections with a set of other UEs, the set of other UEs included among multiple candidate UEs that are candidates for performing a given action with the UE;
logic configured to capture local ambient sound at the UE while connected to the set of other UEs via the set of local P2P wireless connections;
logic configured to report information associated with the local ambient sound captured at the UE to an authentication device configured to authenticate whether or not the UE is in a shared environment with any of the set of other UEs; and
logic configured to select a target UE from the multiple candidate UEs for performing the given action based on whether the authentication device authenticates the UE and any of the set of other UEs as being in the shared environment.

46. An authentication device, comprising:
logic configured to obtain first information associated with local ambient sound captured by a first user equipment (UE);
logic configured to obtain second information associated with local ambient sound captured by a second UE while the second UE is connected to the first UE via a local peer-to-peer (P2P) wireless connection;
logic configured to compare the first and second information to determine a degree of environmental similarity for the first and second UEs; and
logic configured to selectively authenticate the first and second UEs as being in a shared environment based on the determined degree of environmental similarity.

47. A non-transitory computer-readable medium containing instructions stored thereon, which, when executed by a user equipment (UE), cause the UE to perform operations, the instructions comprising:
at least one instruction to cause the UE to establish a set of local peer-to-peer (P2P) wireless connections with a set of other UEs, the set of other UEs included among multiple candidate UEs that are candidates for performing a given action with the UE;
at least one instruction to cause the UE to capture local ambient sound at the UE while connected to the set of other UEs via the set of local P2P wireless connections;
at least one instruction to cause the UE to report information associated with the local ambient sound captured at the UE to an authentication device configured to authenticate whether or not the UE is in a shared environment with any of the set of other UEs; and
at least one instruction to cause the UE to select a target UE from the multiple candidate UEs for performing the given action based on whether the authentication device authenticates the UE and any of the set of other UEs as being in the shared environment.

48. A non-transitory computer-readable medium containing instructions stored thereon, which, when executed by an authentication device, cause the authentication device to perform operations, the instructions comprising:
at least one instruction to cause the authentication device to obtain first information associated with local ambient sound captured by a first user equipment (UE);
at least one instruction to cause the authentication device to obtain second information associated with local ambient sound captured by a second UE while the second UE is connected to the first UE via a local peer-to-peer (P2P) wireless connection;
at least one instruction to cause the authentication device to compare the first and second information to determine a degree of environmental similarity for the first and second UEs; and
at least one instruction to cause the authentication device to selectively authenticate the first and second UEs as being in a shared environment based on the determined degree of environmental similarity.
